(19) United States
(12) Patent Application Publication
(10) Pub. No.: US 2015/0278037 A1
(43) Pub. Date: Oct. 1, 2015

(54) TRANSFER DEVICE, DETERMINATION METHOD, AND DATA PROCESSING DEVICE

(71) Applicant: FUJITSU LIMITED, Kawasaki-shi (JP)

(72) Inventor: Hiroyuki Wada, Kawasaki (JP)

(73) Assignee: Fujitsu Limited

(21) Appl. No.: 14/607,537

(22) Filed: Jan. 28, 2015

(30) Foreign Application Priority Data
Mar. 31, 2014 (JP) 2014-072144

(51) Int. Cl. G06F 11/14; G06F 11/10; G06F 12/08; G06F 11/08; G06F 13/16; G06F 13/28

(52) U.S. Cl. CPC G06F 11/1484; G06F 13/1694; G06F 13/28; G06F 12/0804; G06F 11/08; G06F 11/1064; G06F 2212/621; G06F 2201/815

(57) ABSTRACT

A transfer device that performs data transfer between a memory that stores a plurality of data and a processing unit that executes a main process using the data stored in the memory, the transfer device includes: a control unit that carries out control to, separately from the main process, sequentially read the data stored in the memory for each predetermined unit in address order, and to subject the read data to a predetermined process; and a determination unit that determines a digest value for each of the plurality of predetermined units of data using the data read by the control unit or the data subjected to the predetermined process by the control unit, so that it becomes easy to detect pages of the same content, and sharing and using the pages of the same content by a plurality of virtual machines.

### CROSS-REFERENCE TO RELATED APPLICATION

This application is based upon and claims the benefit of priority of the prior Japanese Patent Application No. 2014-072144, filed on Mar. 31, 2014, the entire contents of which are incorporated herein by reference.

### FIELD

The embodiments discussed herein are related to a transfer device, a determination method, and a data processing device.

### BACKGROUND

A virtual machine (VM) which runs on a physical computer manages memory in page units. Page is a predetermined number of continuous memory elements of a main memory device having a plurality of memory elements such as random access memory (RAM). Here, when each of the VMs running on a single physical computer individually stores data of the same content in a different page corresponding to each of the VMs, plural items of data of the same content are present, and memory capacity of the main memory device is used wastefully. As a result, it may be difficult to increase the number of VMs that may run on a single physical computer.

Therefore, detecting pages of the same content, and sharing and using the pages of the same content have been carried out by the VMs in the related art. The method of detecting pages of the same content is as follows. First, software (a VM manager) calculates a hash value of each page while scanning the main memory device at a predetermined interval of one hour, for example, on a central processing unit (CPU) of the physical computer. Note that, a hash value is a digest value that corresponds to the content of the data of each page and summarizes the content. Next, the VM manager creates a correspondence table of the hash values of each page, the hash values being stored to be associated with each page. The VM manager detects pages of the same content by finding candidates of pages of the same content based on the correspondence table, and rechecking the content of candidate pages.

U.S. Pat. No. 6,789,156 is an example of the related art.

However, the calculation of the hash value of each page described above is executed by a processing unit such as the CPU separately from the main processes that are executed by the processing unit. Therefore, in order to calculate the hash value of each page, the processing unit bears a certain load.

An object of an aspect of the disclosed technology is to reduce the load of the processing unit when calculating the digest value for each predetermined unit of data that is stored in the memory.

### SUMMARY

According to an aspect of the invention, a transfer device that performs data transfer between a memory that stores a plurality of data and a processing unit that executes a main process using the data stored in the memory is disclosed, and the transfer device includes: a control unit that carries out control to, separately from the main process, sequentially read the data stored in the memory for each predetermined unit in address order, and to subject the read data to a predetermined process; and a determination unit that determines a digest value for each of the plurality of predetermined units of data using the data read by the control unit or the data subjected to the predetermined process by the control unit, so that it becomes easy to detect pages of the same content, and sharing and using the pages of the same content by a plurality of virtual machines.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a data processing device of a first embodiment;

FIG. 2 is a block diagram of an error detection and correction circuit;

FIG. 3 is a block diagram of a hash value calculation circuit;

FIG. 4 is a block diagram of an arbitration circuit which arbitrates processing of commands from a reading and writing buffer, writing of hash values to a memory, and scrubbing processes, and a timing adjustment circuit which adjusts the timing of each process;

FIG. 5 is a portion of a timing chart of a control circuit of the first embodiment;

FIG. 6 is the remaining portion of the timing chart of the control circuit of the first embodiment;

FIG. 7 is a timing chart of a calculation process of a hash value, and a scrubbing process of the memory in the related art;

FIG. 8 is a timing chart of a calculation process of a hash value, and a scrubbing process of the memory in the first embodiment;

FIG. 9 is a flowchart illustrating an example of data processing executed by an MPU instead of the control circuit in a modification example of the first embodiment;

FIG. 10 is a block diagram of a data processing device of a second embodiment;

FIG. 11 is a diagram illustrating the content of data that is transmitted and received between a CPU and a memory controller;

FIG. 12 is a flowchart illustrating an example of data processing executed by an MPU instead of the control circuit in a modification example of the second embodiment;

FIG. 13 is a block diagram of a data processing device of the modification example of the second embodiment;

FIG. 14 is a block diagram of a data processing device of a third embodiment;

FIG. 15 is a timing chart of a control circuit of the third embodiment;

FIG. 16 is a block diagram of a data processing device of a fourth embodiment;

FIG. 17 is a diagram illustrating the specific content in which a hash value is updated by calculating a difference of hash values; and

FIG. 18 is a timing chart of a control circuit of the fourth embodiment.

### DESCRIPTION OF EMBODIMENTS

Hereinafter, detailed description will be given of an example of the embodiments of the disclosed technology with reference to the accompanying drawings.

### First Embodiment

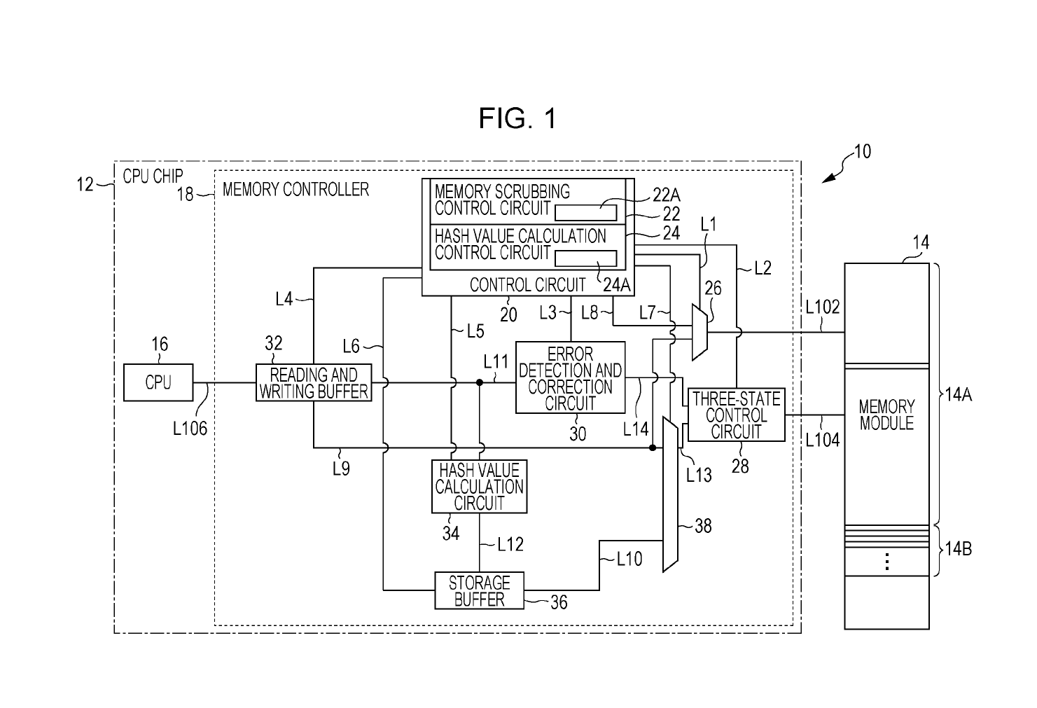

FIG. 1 illustrates a block diagram of a data processing device 10 of the first embodiment. The data processing device 10 is a server device, for example. As illustrated in FIG. 1, the data processing device 10 is provided with a CPU chip 12 and a memory module 14. The CPU chip 12 is provided with one or more CPU 16 and a memory controller 18. The memory module 14 includes a memory, and a control unit. The memory includes a plurality of memory elements which store data by accumulating charges, and the control unit is for controlling the reading and writing of data from and to the plurality of memory elements of the memory. The plurality of memory elements are managed by being divided into a data storage region 14A and a hash value storage region 14B. The CPU 16 (described later) performs reading and writing of data from and to the data storage region 14A, and the hash value storage region 14B is for storing the hash values (described later). The reading and writing of data to and from the memory by the CPU 16 is performed using data of a fixed size convenient to cache management as a unit. The unit is referred to as one cache line, and hereinafter will simply be referred to in short as one line. A predetermined number of memory elements correspond to one line.

Note that, the CPU 16 and the memory controller 18 are not limited to being provided on one chip, and may be provided on separate chips.

A plurality of virtual machines (VMs) run on a physical computer that includes the data processing device 10. Each of the plurality of VMs manages, as one page, data stored in a predetermined number of memory elements that are arranged in a plurality of lines.

The memory controller 18 is provided with a control circuit 20, a first selector 26, a three-state control circuit 28, an error detection and correction circuit 30, a reading and writing buffer 32, a hash value calculation circuit 34, a storage buffer 36, and a second selector 38. The control circuit 20 is provided with a memory scrubbing control circuit 22 and a hash value calculation control circuit 24. The memory scrubbing control circuit 22 is provided with a first address holding circuit 22A, and the hash value calculation control circuit 24 is provided with a second address holding circuit 24A.

A control line L1 that is connected to an output terminal of the control circuit 20 is connected to a control signal input terminal of the first selector 26. A control line L2 that is connected to another output terminal of the control circuit 20 is connected to a control signal input terminal of the three-state control circuit 28. An input terminal of the control circuit 20 is connected to an output terminal of the error detection and correction circuit 30 via a control line L3. The control circuit 20 and the reading and writing buffer 32 are connected to each other via a data transmission line L4. A control line L5 that is connected to another output terminal of the control circuit 20 is connected to a control signal input terminal of the hash value calculation circuit 34. A control line L6 that is connected to another output terminal of the control circuit 20 is connected to a control signal input terminal of the storage buffer 36. A control line L7 that is connected to another output terminal of the control circuit 20 is connected to a control signal input terminal of the second selector 38.

A data transmission line L8 that is connected to another output terminal of the control circuit 20 is connected to one of the two input terminals of the first selector 26. A data transmission line L9 that is connected to the reading and writing buffer 32 is connected to the other input terminal of the first selector 26. The data transmission line L9 that is connected to the reading and writing buffer 32 is connected to one of the two input terminals of the second selector 38. A data transmission line L10 that is connected to the storage buffer 36 is connected to the other input terminal of the second selector 38. The hash value calculation circuit 34 is connected to the storage buffer 36 via a data transmission line L12.

Of the first to the third terminals of the three-state control circuit 28, the first terminal is connected to the output terminal of the second selector 38 via a data transmission line L13, and the second terminal is connected to the error detection and correction circuit 30 via a data transmission line L14. The data transmission line L11 of the error detection and correction circuit 30 is connected to the reading and writing buffer 32 and the hash value calculation circuit 34.

The output terminal of the first selector 26 is connected to the memory module 14 via a data transmission line L102. The third terminal of the three-state control circuit 28 is connected to the memory module 14 via a data transmission line L104. The reading and writing buffer 32 and the CPU 16 are connected to each other using a data transmission line L106.

The first selector 26 outputs data that is selected from the following two data according to the content of the signal received from the control circuit 20 via the control line L1 to the memory module 14. One of the two data is the data that is input from the control circuit 20 via the data transmission line L8. The other of the two data is the data that is input from the reading and writing buffer 32 via the data transmission line L9.

The second selector 38 outputs data to the three-state control circuit 28 in the following manner according to the content of the signal that is input from the control circuit 20 via the control line L7. The second selector 38 outputs the data that is input from the reading and writing buffer 32 via the data transmission line L9, or the data that is input from the storage buffer 36 via the data transmission line L10 to the three-state control circuit 28 via the data transmission line L13.

If a control signal is not input to the three-state control circuit 28 from the control circuit 20 via the control line L2, the three-state control circuit 28 outputs the data that is input from the memory module 14 via the data transmission line L104 to the error detection and correction circuit 30 via the data transmission line L14. When a control signal is input to the three-state control circuit 28 from the control circuit 20 via the control line L2, the three-state control circuit 28 outputs data to the memory module 14 in the following manner according to the input control signal. The three-state control circuit 28 transmits the data (1 or 0) that is input from the second selector 38 via the data transmission line L13 to the memory module 14 via the data transmission line L104.

The memory controller 18 is an example of the “transfer device” of the disclosed technology.

The memory scrubbing control circuit 22 is an example of the “control unit” of the disclosed technology.

The hash value calculation circuit 34 is an example of the “determination unit” of the disclosed technology.

The data processing device 10 is an example of the “data processing device” of the disclosed technology.

The memory in the memory module 14 is an example of the “memory” of the disclosed technology.

The CPU 16 is an example of the “processing unit” of the disclosed technology.

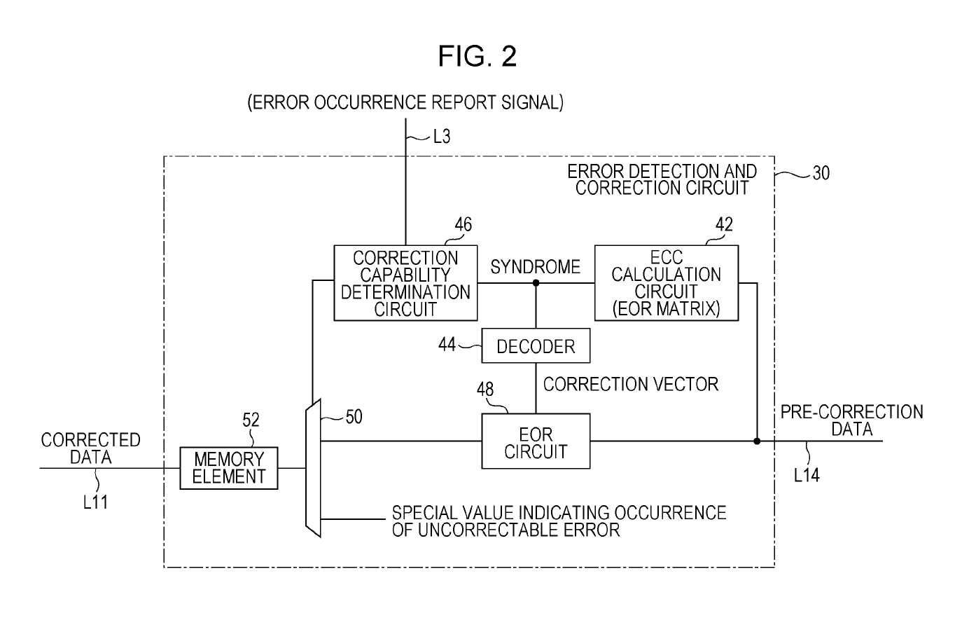

FIG. 2 is a block diagram of the error detection and correction circuit 30. As illustrated in FIG. 2, the error detection and correction circuit 30 is provided with an error correcting code (ECC) calculation circuit 42, a decoder 44, and a correction capability determination circuit 46. The error detection and correction circuit 30 is also provided with an exclusive OR (EOR) circuit 48, a selector 50, and a memory element 52.

The input terminal of the ECC calculation circuit 42 and one of the two input terminals of the EOR circuit 48 are connected to the three-state control circuit 28 via the data transmission line L14. The output terminal of the ECC calculation circuit 42 is connected to both the input terminal of the decoder 44 and the input terminal of the correction capability determination circuit 46. The output terminal of the decoder 44 is connected to the other input terminal of the EOR circuit 48. The output terminal of the EOR circuit 48 is connected to one of the two input terminals of the selector 50. A special value that indicates the occurrence of uncorrectable error is input to the other input terminal of the selector 50. One of the output terminals of the correction capability determination circuit 46 is connected to the control signal input terminal of the selector 50. The other output terminal of the correction capability determination circuit 46 is connected to the control circuit 20 via the control line L3. The output terminal of the selector 50 is connected to the input terminal of the memory element 52. The output terminal of the memory element 52 is connected to the reading and writing buffer 32 and the hash value calculation circuit 34 via the data transmission line L11.

Here, description will be given of the operations of the error detection and correction circuit 30. When the memory element of the memory is irradiated with a cosmic ray, for example, from outside of the memory controller 18, there is a case in which the charge holding state in the memory element of the memory is inverted, and an error occurs in the stored content of the memory. The error detection and correction circuit 30 corrects such an error as follows.

To facilitate explanation, it is assumed that four bits of data that are identified as A, B, C, and D are input to the ECC calculation circuit 42 and the EOR circuit 48 at the same time. The data that are input at the same time include not only the four bits of data, but also error correcting code (ECC) data relating to the four bits of data. The ECC data is configured by, for example, four bits of E, F, G, and H. E is the EOR of A, B, and C, F is the EOR of B, C, and D, G is the EOR of C, D, and A, and H is the EOR of D, A, and B.

Note that, in the example described above, the data transmission line L14 includes a total of eight lines, the data of A, B, C, and D, and the ECC data E, F, G, and H relating thereto. As described above, to facilitate explanation, the data that is input to the ECC calculation circuit 42 and the EOR circuit 48 at the same time is set to the data of A, B, C, and D, and the ECC data E, F, G, and H. However, in actuality, the data of a larger number of bits is input to the ECC calculation circuit 42 and the EOR circuit 48 at the same time.

The ECC calculation circuit 42 to which the data of A, B, C, D, E, F, G, and H is input calculates first to fourth syndrome bits from the data of A to H that is input. The first syndrome bit is the EOR of A, B, C, and E, the second syndrome bit is the EOR of B, C, D, and F, the third syndrome bit is the EOR of C, D, A, and G, and the fourth syndrome bit is the EOR of D, A, B, and H. The ECC calculation circuit 42 outputs the syndrome to the decoder 44 and the correction capability determination circuit 46.

Specifically, the syndrome is a signal which indicates whether or not there is an error in the data of A to H in which data or the like is inverted by a cosmic ray; and, when there is an error, indicates which data of A to H the error is present in. The decoder 44 decodes the syndrome and generates a correction vector. For example, it is assumed that the data of A to H is originally 00010111; however, there is an error in the data of B, and the data of A to H that is input is 01010111. The ECC calculation circuit 42 outputs a syndrome 1101 indicating that there is a correctable error in B, based on the input values 01010111. The decoder 44 decodes the syndrome 1101, and outputs 01000000 to the EOR circuit 48 as the correction vector. The EOR circuit 48 calculates the EOR of 01010111 and 01000000, and the data of 00010111, that is, the original data in which the error is corrected is input to the selector 50.

In the example described above, when there is an error in one of the bits of the data of A to H, it is possible to correct the error. However, when a plurality of errors are present in the data of A to H, the ECC calculation circuit 42 may not be able to determine which data of A to H the errors are present in. In this case, the ECC calculation circuit 42 outputs a syndrome indicating that the data is uncorrectable to the decoder 44 and the correction capability determination circuit 46.

In this manner, there are three types of syndrome, a first type of syndrome indicating that there is no error, a second type of syndrome indicating which data a correctable error is present in, and a third type of syndrome indicating that the error may not be corrected. When the first or second type of syndrome is input to the correction capability determination circuit 46, the correction capability determination circuit 46 outputs a signal that controls the selector 50 to select the signal from the EOR circuit 48 to the selector 50. When the third type of syndrome is input to the correction capability determination circuit 46, the correction capability determination circuit 46 outputs a signal that controls the selector 50 to select the signal of a special value indicating the occurrence of an uncorrectable error to the selector 50. The timing of the signal that is selected by the selector 50 is adjusted via the memory element 52, and output to the reading and writing buffer 32 and the hash value calculation circuit 34 via the data transmission line L11.

Note that, when the second type of syndrome is input to the correction capability determination circuit 46, the correction capability determination circuit 46 outputs a signal indicating the presence of a correctable error to the control circuit 20 via the data transmission line L3. When the third type of syndrome is input to the correction capability determination circuit 46, the correction capability determination circuit 46 outputs a signal indicating that the error may not be corrected to the control circuit 20 via the data transmission line L3. On receiving the input of the signal indicating that the error may not be corrected, the control circuit 20 causes a display device (not illustrated) to display that the error may not be corrected.

While described later in detail, the memory scrubbing control circuit 22 sequentially reads data of a target region (for example, an entire region) of the data storage region 14A from the memory module 14 for every ⅛ of a line, for example, in address order. The read data is input to the error detection and correction circuit 30, and is subjected to error detection and correction of correctable errors. A process in which the detection and correction of the errors is performed periodically on a predefined range of a data storage region to keep errors from developing to an uncorrectable level is referred to as a scrubbing process of the memory.

The data of a total of four of the ⅛ of the data of one line of the memory, for example, (refer to A, B, C, and D described above) is an example of the “predetermined unit of data” of the disclosed technology.

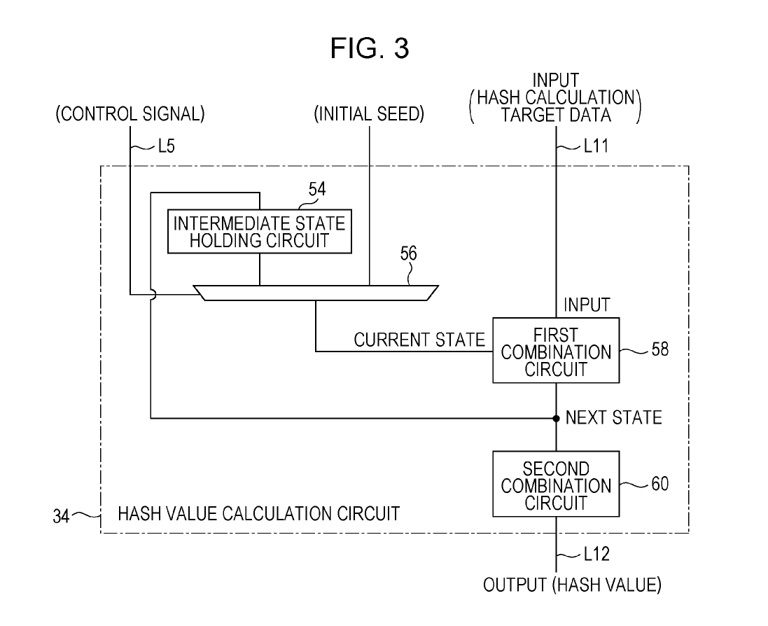

FIG. 3 illustrates a block diagram of the hash value calculation circuit 34. As illustrated in FIG. 3, the hash value calculation circuit 34 is provided with an intermediate state holding circuit 54, a selector 56, a first combination circuit 58, and a second combination circuit 60.

The output terminal of the first combination circuit 58 is connected to the input terminal of the intermediate state holding circuit 54. The output terminal of the intermediate state holding circuit 54 is connected to one of the two input terminals of the selector 56. An initial seed indicating a predetermined value is input to the other input terminal of the selector 56. The control signal input terminal of the selector 56 is connected to the control circuit 20 via the control line L5. The error detection and correction circuit 30 is connected to one of the two input terminals of the first combination circuit 58 via the data transmission line L11. The output terminal of the selector 56 is connected to the other input terminal of the first combination circuit 58. The output terminal of the first combination circuit 58 is connected to the input terminal of the second combination circuit 60. The output terminal of the second combination circuit 60 is connected to the storage buffer 36 via the data transmission line L12.

Here, description will be given of the operations of the hash value calculation circuit 34. A plurality of VMs run on a physical computer that contains the data processing device 10. Each of the plurality of VMs manages, as one page, data stored in a predetermined number of memory elements that are arranged in a plurality of lines. Each of the VMs shares and uses the pages of the same stored content. The hash value of each page is stored in the hash value storage region 14B of the memory, the hash values being associated with each page. The software (the VM manager) running on the CPU 16 creates a correspondence table from the hash values of each page, the hash values being stored in association with each page, and detects pages of the same content based on the correspondence table. The hash value calculation circuit 34 calculates the hash values of the pages. The hash values are digest values that correspond to the content of the data of each page and summarize the content. Hereinafter, description will be given of the operations of the hash value calculation circuit 34 when the hash value of one page is calculated. Note that, hereinafter, description will be given of the operations of the hash value calculation circuit 34 to which a CRC 32 function is applied as an example of a hashing function for calculating a hash value.

In the initial stage of processing the data of the first line when calculating the hash value of one page, the control circuit 20 controls the selector 56 to select the initial seed. Accordingly, the initial seed is input from the selector 56 to the first combination circuit 58 as the current state. Data in which the correctable errors are corrected is input to the first combination circuit 58 from the error detection and correction circuit 30 via the data transmission line L11. When one line of data is input to the first combination circuit 58, the first combination circuit 58 processes the data as follows.

As an example, it is assumed that the number of bits in one line of data is 64 bits. The first combination circuit 58 divides both the 32 bit current state and the 64 bit data that is input into bit units, and obtains an input of a total of 96 bits. The first combination circuit 58 selects, from the 96 bit input, approximately 48 bits for each of 32 different combinations that are separately predefined, and calculates all the EORs of the selected 48 bits in relation to each of the 32 combinations. The first combination circuit 58 outputs the EOR values that are calculated in relation to each of the 32 combinations to the second combination circuit 60 and the intermediate state holding circuit 54 as the next state. The intermediate state holding circuit 54 holds the value that is input from the first combination circuit 58.

The second combination circuit 60 outputs values, which are obtained by inverting all the bits, a bit at a time, of the values that are input from the first combination circuit 58, to the storage buffer 36 as a hash value. Note that, at the stage at which the first line of data is processed, the values that are output from the second combination circuit 60 as the hash values are not the hash values of one page of data, therefore, the control circuit 20 does not control the storage buffer 36 to store the hash values.

The control circuit 20 controls the selector 56 to select the data from the intermediate state holding circuit 54 until the data from the second line to the final line of one page is processed. Accordingly, the data from the intermediate state holding circuit 54 is input to the first combination circuit 58 from the selector 56. Subsequently, the first combination circuit 58 and the second combination circuit 60 subject the data from the second line to the final line of one page to the same process as the data of the first line.

At the state at which the data of one page is processed to the final line, the values that are output from the second combination circuit 60 as the hash values are the hash values of one page of data. Accordingly, the control circuit 20 controls the storage buffer 36 to store the hash values. The hash values and the pages are associated with each other and the hash value are stored in the hash value storage region 14B.

Note that, one page of data is an example of “a plurality of predetermined units of data” of the disclosed technology.

In the related art, since the calculation of the hash values is performed by the CPU 16, the data have to be moved from the memory module 14 to the CPU 16. However, in the first embodiment, as illustrated in FIG. 1, the hash value calculation circuit 34 and the storage buffer 36 are disposed in a position that is physically closer to the memory module 14 than the CPU 16. Accordingly, in the first embodiment, in order to calculate the hash values, it is sufficient to move the data from the memory module 14 to a position that is closer than the CPU 16 without moving the data to the CPU 16.

Since the calculation of the hash values described above is realized using a combination of logical functions such as EOR and AND, it is possible to realize the hash value calculation circuit 34 using simple hardware.

However, the scrubbing process and the hash value calculation process are not the only processes performed on the data that is stored in the memory module 14. In order to carry out the main processes, the CPU 16 controls the control circuit 20 to read data from the memory, and to write data to the memory. Specifically, in order to carry out the main processes, the CPU 16 stores command data, which commands the control circuit 20 to read data from the memory and to write data to the memory, and data to be written to the memory in the reading and writing buffer 32. Note that, the main processes refers to processes of the VMs that are executed on the CPU 16, the VM manager, the application programs executed on the VMs, and the like.

Here, it is conceivable that there is a case in which the requests for reading data from the memory for the main processes of the CPU 16 and the like, and reading data from the memory for the scrubbing process and the hash value calculation process will be generated at the same time. However, there is a fixed limit to the ability to process the reading of data from the memory in the memory module 14. Accordingly, when the main processes are delayed in such a case, there is a concern that the execution time of the main processes will be increased.

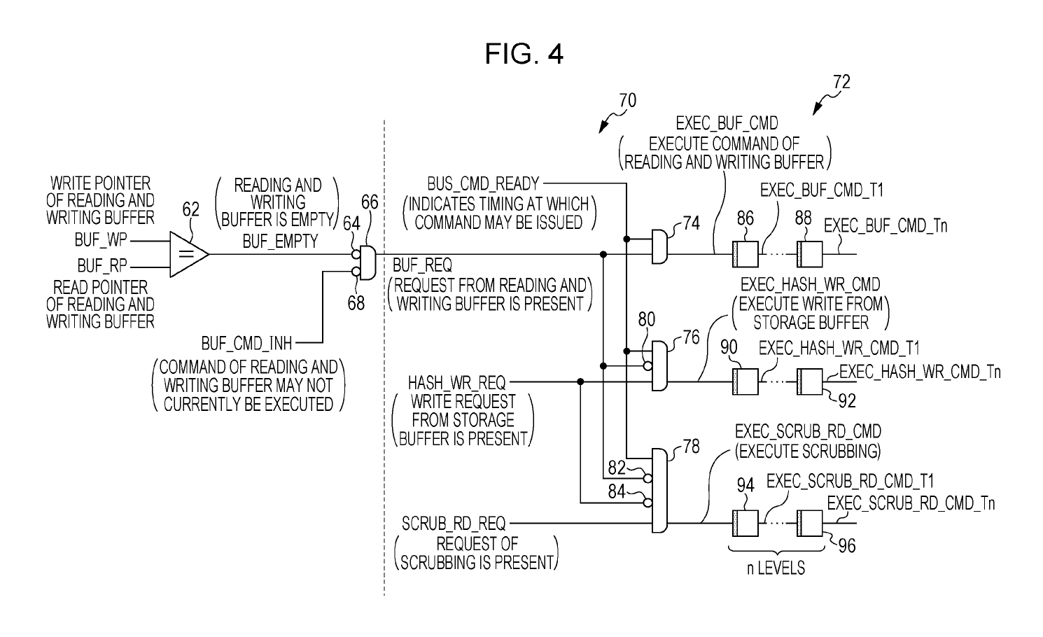

Therefore, in the first embodiment, the control circuit 20 executes the scrubbing process and the hash value calculation process, and the process of writing the hash values to the memory in the time in which the CPU 16 is not executing the main processes (idle time). In other words, when a bus such as the data bus or the address bus of the memory module is in the idle state, the control circuit 20 executes the scrubbing process and the hash value calculation process, and the process of writing the hash values to the memory. FIG. 4 illustrates a block diagram of an arbitration circuit 70 which arbitrates processing of commands from the reading and writing buffer 32, writing of the hash values to the memory, and scrubbing processes, and a timing adjustment circuit 72 which adjusts the timing of each process. Note that, since the calculation process of the hash value is performed using the data that is read by the scrubbing process, the calculation process of the hash value is mediated by the mediation of the scrubbing process and the other processes.

First, description will be given of the configuration of the reading and writing buffer 32. As illustrated in FIG. 4, the reading and writing buffer 32 is provided with a comparison circuit 62, and an AND circuit 66. The AND circuit 66 is provided with inverting circuits 64 and 68 on two input terminals, respectively. In order to carry out the main processes, the CPU 16 stores command data for commanding the control circuit 20 to read data from the memory and to write data to the memory in the reading and writing buffer 32. The reading and writing buffer 32 is provided with a first holding portion (not illustrated) that holds a pointer indicating a writing region in which command data is newly stored. A pointer BUF_WP indicating the region in which command data is newly stored is input to one of the two input terminals of the comparison circuit 62 from the first holding portion.

The command data that is stored in the reading and writing buffer 32 is executed in order of the time at which the command data is stored, from the oldest time. Therefore, the reading and writing buffer 32 is provided with a second holding portion (not illustrated) that holds a pointer indicating a read region in which the command data of the command to be executed after the command that is already executed is stored. A pointer BUF_RP indicating the region in which command data of the command to be executed next is stored is input to the other input terminal of the comparison circuit 62 from the second holding portion.

When the two signals that are input to the comparison circuit 62 are equal, the comparison circuit 62 outputs a high-state signal, and when the two signals that are input are different, the comparison circuit 62 outputs a low-state signal.

When the command data of a command that is yet to be executed is present in the reading and writing buffer 32, the pointer BUF_WP and the pointer BUF_RP indicate different regions. In this case, the comparison circuit 62 outputs a low-state BUF_EMPTY signal. Meanwhile, when there is no command data of commands yet to be executed due to the commands being executed based on the command data in the reading and writing buffer 32 (the idle state), the pointer BUF_WP and the pointer BUF_RP indicate the same region. In this case, the comparison circuit 62 outputs a high-state BUF_EMPTY signal. The output terminal of the comparison circuit 62 is connected to one of the input terminals of the AND circuit 66 via the inverting circuit 64.

A BUF_CMD_INH signal is input to the other input terminal of the AND circuit 66 via the inverting circuit 68. When the control circuit 20 may not currently execute the command of the reading and writing buffer 32, the BUF_CMD_INH signal is a high-state signal, and when the control circuit 20 may currently execute the command, the BUF_CMD_INH signal is a low-state signal. For example, when data is read from the memory module 14, when the next command that is stored in the reading and writing buffer 32 is a command for writing data to the memory or the like, there is a case in which the control circuit 20 may not execute the command of the reading and writing buffer 32. In this case, the BUF_CMD_INH signal is in the high state, and a low-state signal is input to the other input terminal of the AND circuit 66 via the inverting circuit 68.

When the control circuit 20 may currently the command of the reading and writing buffer 32, the BUF_CMD_INH signal is in the low state, and a high-state signal is input to the other input terminal of the AND circuit 66 via the inverting circuit 68. In this state, when the control circuit 20 is not in the idle state, that is, when a command has to be executed, the BUF_EMPTY signal is in the low state, and the high-state signal is input to one of the input terminals of the AND circuit 66 via the inverting circuit 64. Accordingly, the AND circuit 66 outputs the high-state BUF_REQ signal to the control circuit 20. In other words, when the BUF_REQ signal is in the high state, the BUF_REQ signal indicates that there is a request for reading from or writing to the memory from the reading and writing buffer 32, and when the BUF_REQ signal is in the low state, the BUF_REQ signal indicates that there is no request.

Next, description will be given of the configuration of the control circuit 20 for arbitrating the processes described above. As illustrated in FIG. 4, the control circuit 20 includes the arbitration circuit 70 and the timing adjustment circuit 72 in a different position from that in which the memory scrubbing control circuit 22 and the hash value calculation control circuit 24 are disposed.

The arbitration circuit 70 is provided with an AND circuit 74, an AND circuit 76, and an AND circuit 78. An inverting circuit 80 is provided on only one of the three input terminals of the AND circuit 76, and inverting circuit 82 and inverting circuit 84 are provided on two of the input terminals, respectively, of the four input terminals of the AND circuit 78.

A BUS_CMD_READY signal is input to one of the input terminals of the AND circuit 74, the input terminal of the AND circuit 76 on which the inverting circuit 80 is not provided, and the input terminal of the AND circuit 78 on which the inverting circuits 82 and 84 are not provided. The BUS_CMD_READY signal is a signal indicating the timing at which a command may be issued, and is output from an output portion (not illustrated).

The BUF_REQ signal is input to the other input terminal of the AND circuit 74. The BUF_REQ signal is also input to the inverting circuit 80 that is provided on the input terminal of the AND circuit 76, and to the inverting circuit 82 on which the input terminal of the AND circuit 78 is provided.

An output circuit (not illustrated) which outputs a HASH_WR_REQ signal to the control circuit 20 via the control line L6 is provided in the storage buffer 36. The HASH_WR_REQ signal is a signal which requests that a plurality of hash values stored in the storage buffer 36 be stored in the memory. The plurality of hash values are a number of hash values that may be stored in one line of memory, which is the unit that is written to the memory. The HASH_WR_REQ signal is input the other input terminal of the AND circuit 76 on which the inverting circuit 80 is not provided, and to the inverting circuit 84 which is provided on the input terminal side of the AND circuit 78.

A SCRUB_RD_REQ signal that assumes the high state when there is a scrubbing process request from the CPU 16 via the reading and writing buffer 32 and assumes the low state when there is no request is input to the control circuit 20. The SCRUB_RD_REQ signal is input to the other input terminal of the AND circuit 78 on which the inverting circuits 82 and 84 are not provided.

In a state in which the control circuit 20 has to execute a command from the CPU 16 (a state that is not the idle state), the high-state BUF_REQ signal is output from the AND circuit 66 to the AND circuit 74. In this state, when the high-state BUS_CMD_READY signal is input to the AND circuit 74, the AND circuit 74 outputs a high-state EXEC_BUF_CMD signal. Note that, the high-state BUF_REQ signal is input to the inverting circuit 80 that is provided on the input terminal of the AND circuit 76, and to the inverting circuit 82 on which the input terminal of the AND circuit 78 is provided. Accordingly, when the control circuit 20 is in a state that is not the idle state, the signals output from the AND circuit 76 and the AND circuit 78 assume the low state. Accordingly, the scrubbing process, the writing of hash values to the memory, and the writing of the hash values stored in the storage buffer 36 to the memory are not instructed.

Meanwhile, when the control circuit 20 is in the idle state, the BUF_REQ signal assumes the low state. Accordingly, the signal that is output from the AND circuit 74 assumes the low state, and the command from the CPU 16 is not executed. When the BUF_REQ signal is in the low state, a high-state signal is input to the AND circuit 76 via the inverting circuit 80, and a high-state signal is input to the AND circuit 78 via the inverting circuit 82.

The AND circuit 78 outputs the following signal only in a case in which the control circuit 20 is in the idle state, the HASH_WR_REQ signal is in the low state, and the high-state SCRUB_RD_REQ signal and the high-state BUS_CMD_READY signal are input to the AND circuit 78. The AND circuit 78 outputs a high-state EXEC_SCRUB_RD_CMD signal indicating that the scrubbing process will be executed.

The AND circuit 76 outputs the following signal only in a case in which the control circuit 20 is in the idle state, and the high-state HASH_WR_REQ signal and the high-state BUS_CMD_READY signal are input to the AND circuit 76. The AND circuit 76 outputs an EXEC_HASH_WR_CMD signal indicating that the writing of the hash values stored in the storage buffer 36 to the memory will be executed. Note that, the HASH_WR_REQ signal is input to the inverting circuit 84 that is provided on the input terminal of the AND circuit 78. Therefore, when the HASH_WR_REQ signal is in the high state, the high-state EXEC_SCRUB_RD_CMD signal is not output from the AND circuit 78.

The timing adjustment circuit 72 is provided with memory elements 86 to 88, memory elements 90 to 92, and memory elements 94 to 96 for adjusting the timing, the memory elements 86 to 88, 90 to 92, and 94 to 96 being connected to the respective output terminals of the AND circuit 74, the AND circuit 76, and the AND circuit 78.

The timing adjustment circuit 72 adjusts the timing at which the signals instructing the execution of the processes are input to the selector or the like in order to perform the following control at a predetermined timing after each of the signals from the AND circuit 74, the AND circuit 76, and the AND circuit 78 is output. The signals that are output from each of the AND circuit 74, the AND circuit 76, and the AND circuit 78 are stored in each of the memory elements 86 to 88, 90 to 92, and 94 to 96 while shifting for each cycle. Each of the memory elements 86 to 88, 90 to 92, and 94 to 96 output the stored signals. In FIG. 4, the “T1” appended to the signal that is output from each of the memory elements 86 to 88, 90 to 92, and 94 to 96 represents the output from the first level memory element, and “Tn” represents the output from the n-th level memory element. Therefore, the signal is extracted from the memory element of a level corresponding to a predetermined timing at which the next control is performed, and is output to the selector or the like for performing the next control. Accordingly, it is possible to adjust the timing of the process that is instructed by the signals output from each of the AND circuit 74, the AND circuit 76, and the AND circuit 78.

As described above, in the first embodiment, the processing of commands from the reading and writing buffer 32, the process of writing of the hash values to the memory, and the scrubbing processes are mediated, and the timing of each process is adjusted.

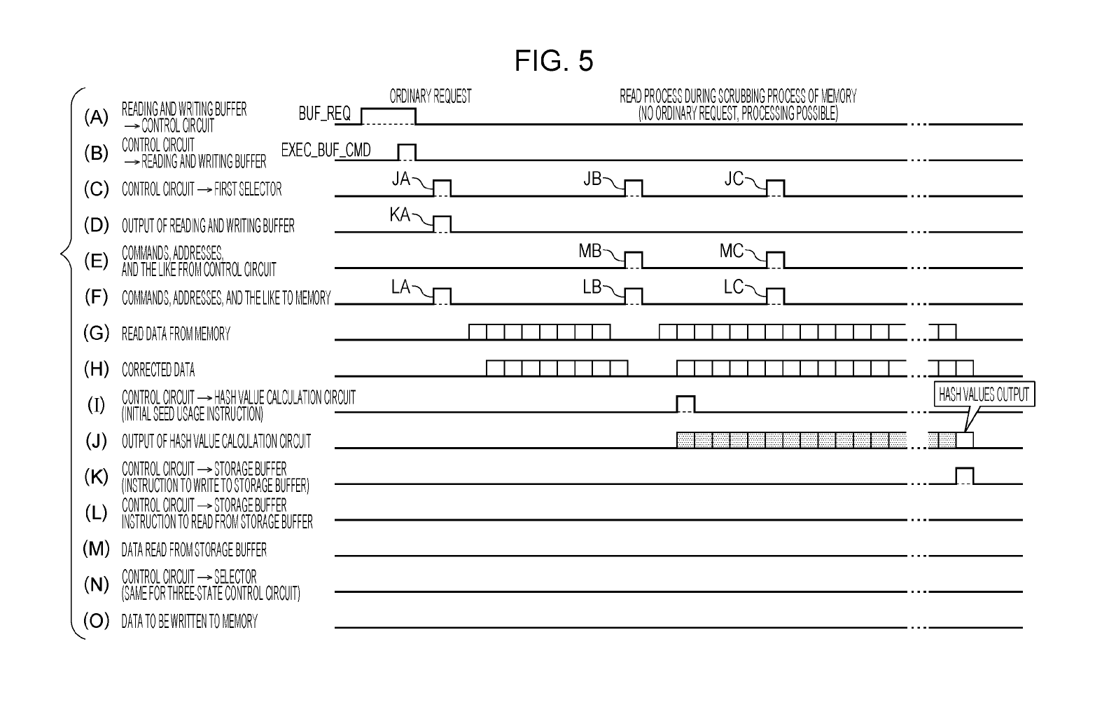

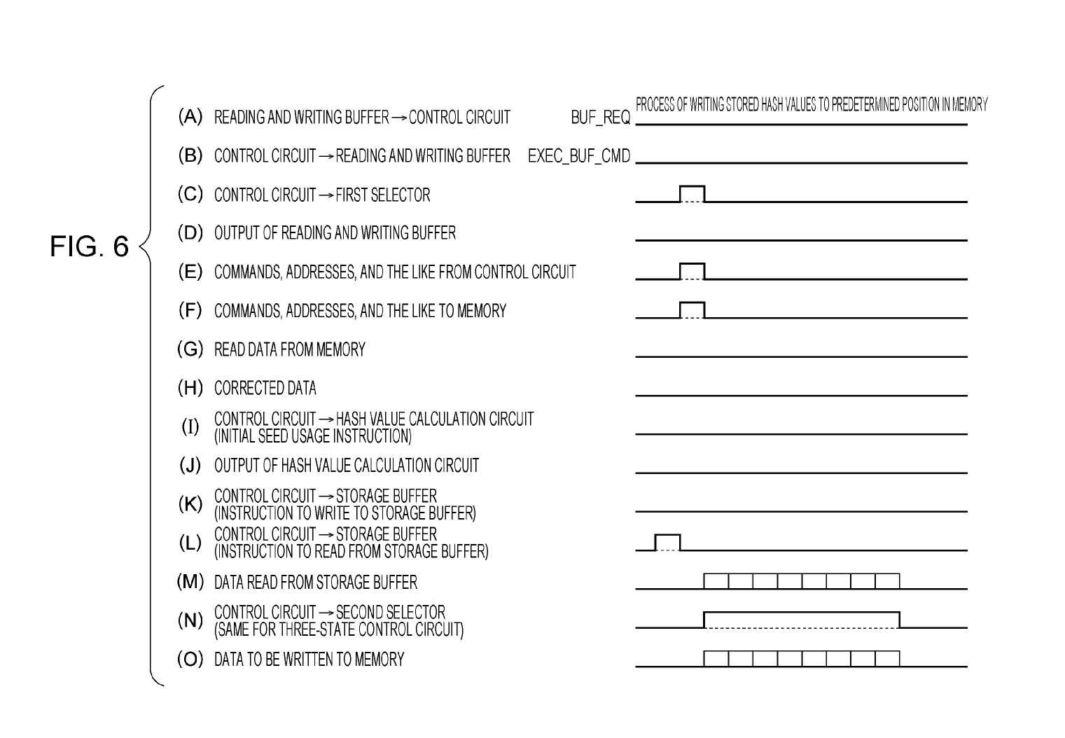

Next, description will be given of the operations of the data processing device 10 with reference to the timing charts of FIGS. 5 and 6. First, description will be given of a process of reading data from memory for the main process of the CPU 16.

Command data of a command to read data from the memory for the main process of the CPU 16 is written to the reading and writing buffer 32, and as illustrated in (A) of FIG. 5, the high-state BUF_REQ signal (also refer to FIG. 4) is input to the control circuit 20 from the reading and writing buffer 32. When the BUS_CMD_READY signal (not illustrated in FIG. 5) assumes the high state, as illustrated in (B) of FIG. 5, the control circuit 20 outputs the high-state EXEC_BUF_CMD signal to the reading and writing buffer 32. The timing of the EXEC_BUF_CMD signal is adjusted by the memory elements 86 to 88 of FIG. 4, and when a fixed period elapses from the time at which the high-state EXEC_BUF_CMD signal is output, the control circuit 20 controls the first selector 26 as follows. As illustrated in (C) of FIG. 5 (refer to JA), the control circuit 20 controls to first selector 26 to select the read command and the address that are written to the reading and writing buffer 32 from the CPU 16. Accordingly, as illustrated in (D) of FIG. 5 (refer to KA) and (F) of FIG. 5 (refer to LA), the signals indicating the read command and the address are input to the memory module 14 from the reading and writing buffer 32.

The memory module 14 reads the data from the specified address based on the input signal, and, as illustrated in (G) of FIG. 5, the data that is read (the Read data) is input to the error detection and correction circuit 30 via the three-state control circuit 28. In the error detection and correction circuit 30, the Read data is subjected to error detection and correction, and as illustrated in (H) of FIG. 5, the Read data that is subjected to the error detection and correction (the corrected data) is stored in the reading and writing buffer 32. Subsequently, the corrected data that is stored in the reading and writing buffer 32 is sent to the CPU 16 via the data transmission line L106, and the CPU 16 executes the main process.

Next, description will be given of the scrubbing process of the memory when the control circuit 20 assumes the idle state. As described above, when the control circuit 20 is in the idle state, the BUF_REQ signal assumes the low state. Accordingly, a high-state signal is input to the AND circuit 78 illustrated in FIG. 4 from the inverting circuit 82. Here, the HASH_WR_REQ signal is assumed to be in the low state. In other words, the high-state signal is input to the AND circuit 78 from the inverting circuit 84. When the high-state BUS_CMD_READY signal, and the high-state SCRUB_RD_REQ signal from the CPU 16 are input to the AND circuit 78, the high-state EXEC_SCRUB_RD_CMD signal is input to the memory scrubbing control circuit 22. An address that is specified using a unit (not illustrated) is held in advance in the first address holding circuit 22A.

As illustrated in (C) of FIG. 5 (refer to JB), the memory scrubbing control circuit 22 outputs a signal which controls the first selector 26 to select the signals indicating the read command and the address from the control circuit 20. As illustrated in (E) of FIG. 5 (refer to MB), the memory scrubbing control circuit 22 outputs an address indicating the first line of a region of the data storage region 14A to be the scrubbing process target, and a command to read the data of the line to the first selector 26. Since the first selector 26 is controlled to select the signals indicating the command and the address from the control circuit 20, as illustrated in FIG. 5 (refer to LB), the signal indicating the read command and the address is output from the control circuit 20 to the memory module 14.

The memory module 14 reads the data from the specified address based on the input signal, and, as illustrated in (G) of FIG. 5, the data that is read (the Read data) is input to the error detection and correction circuit 30 via the three-state control circuit 28. In the error detection and correction circuit 30, the Read data is subjected to error detection and correction processes. As illustrated in (H) of FIG. 5, the Read data that is subjected to the error detection and correction processes (the corrected data) is input to the reading and writing buffer 32 and the hash value calculation circuit 34. Note that, when there is a correctable error in the Read data, the corrected data that is stored in the reading and writing buffer 32 is written back to the same region of the memory at a predetermined timing.

When the corrected data of the first line in a page is input to the hash value calculation circuit 34 in the region of the data storage region 14A to be the target of the scrubbing process, the hash value calculation control circuit 24 controls the selector 56 (also refer to FIG. 3) as follows. As illustrated in (I) of FIG. 5, the hash value calculation control circuit 24 controls the selector 56 (also refer to FIG. 3) to select the initial seed. The hash value calculation circuit 34 updates the intermediate results of the hash values for every data of ⅛ of each line, for example, and outputs the hash values from the top of the page to that point in time. As described above, one page includes the data of a plurality of lines. When the corrected data of one page of the plurality of lines is processed, the values that are output from the second combination circuit 60 are the hash value of one page. Therefore, as illustrated in (K) of FIG. 5, when the corrected data of one page of the plurality of lines is processed, the hash value calculation control circuit 24 controls the storage buffer 36 to store the hash values that are output from the second combination circuit 60.

Subsequently, the same process as that described above is executed up to the final line of the entire region of the data storage region 14A to be the target of the scrubbing process. Each time the scrubbing process of each line is executed, the memory scrubbing control circuit 22 increments the address of the first address holding circuit 22A to the address of the next line.

Note that, in the example illustrated in FIG. 5, when the memory module 14 reads one line, the memory module 14 reads the data of the next line with no substantial delay and outputs the data to the memory controller 18. However, originally, the scrubbing process is normally performed when the CPU 16 is in the idle state so as not to interfere with the main processes; therefore, there is a case in which, after reading the memory of the one line, there is a time delay before reading the data of the next line to the memory.

However, there may not be enough storage capacity to store the hash values of all of the pages in the storage buffer 36. Therefore, in the first embodiment, when a plurality of hash value that may be stored in one line of the memory is stored in the storage buffer 36, the plurality of hash values stored in the storage buffer 36 are stored in the hash value storage region 14B of the memory. The process will be described with reference to the timing chart of FIG. 6.

The storage buffer 36 is provided with an output circuit (not illustrated) which sets the HASH_WR_REQ signal illustrated in FIG. 4 to the high state and outputs the HASH_WR_REQ signal to the control circuit 20 when the plurality of hash values of one line of memory are stored. When the plurality of hash values of one line of memory are stored in the storage buffer 36, the high-state HASH_WR_REQ signal is input to the AND circuit 76. In this state, the BUF_REQ signal that is output from the reading and writing buffer 32 is in a low state, a high-state signal is input to the AND circuit 76 from the inverting circuit 80, and the high-state BUS_CMD_READY signal is input to the AND circuit 76. In this case, the high-state EXEC_HASH_WR_CMD signal is output from the AND circuit 76 and input to the hash value calculation control circuit 24.

The hash value calculation control circuit 24 to which the high-state EXEC_HASH_WR_CMD signal is input, as illustrated in (L) of FIG. 6, outputs a signal instructing the reading of a hash value to the storage buffer 36. Using the memory elements 90 to 92, the hash value calculation control circuit 24 outputs a signal that causes the first selector 26 to select the signal indicating the write command and the address from the control circuit 20 to the first selector 26 after a predetermined time from when the signal instructing of the hash value is output. Accordingly, as illustrated in (E) of FIG. 6, the signal indicating the write command and the address is output from the control circuit 20, and, as illustrated in (F) of FIG. 6, the signal is output to the memory module 14 via the first selector 26. Therefore, the memory module 14 assumes a state in which it is possible to write one line of hash values at the next timing after a predetermined time.

Therefore, according to the signal of an instruction to read the hash values from the hash value calculation control circuit 24 illustrated in (L) of FIG. 6, the plurality of hash values of one line of memory are read from the storage buffer 36, as illustrated in (M) of FIG. 6, and output to the second selector 38. The control circuit 20 outputs a signal to the second selector 38 such that the second selector 38 selects the data from the storage buffer 36, as illustrated in (N) of FIG. 6, at the timing at which the plurality of hash values illustrated in (M) of FIG. 6 are output to the second selector 38. Note that, the three-state control circuit 28 is also controlled in the same manner as the second selector 38. Accordingly, the plurality of hash values of one line of memory that are read from the storage buffer 36 are output to the memory module 14 via the second selector 38 and the three-state control circuit 28. The plurality of hash values are written to the region of the specified address in the hash value storage region 14B. Note that, the address to which the hash values are written is set in the second address holding circuit 24A in advance using a unit (not illustrated), and when the hash values are written to the memory, the number of addresses set in the second address holding circuit 24A increases by the amount of hash values that are written.

Next, description will be given of the effects of the first embodiment.

### First Effect

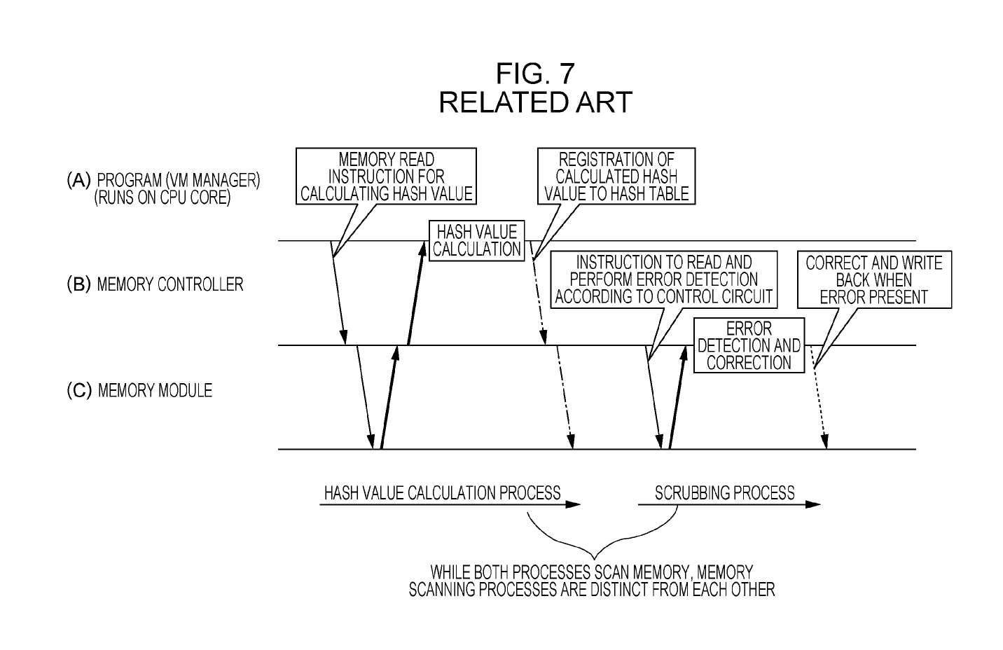

In the related art, as illustrated in (A) of FIG. 7, a VM manager running on a CPU instructs the reading of data from memory in order to calculate a hash value. As illustrated in (B) of FIG. 7, the memory controller instructs the memory module to read the data based on the instruction to read the data. The memory module reads the data and outputs the data to the memory controller as illustrated in (C) of FIG. 7, and the memory controller outputs the data from the memory to the CPU as illustrated in (B) of FIG. 7. As illustrated in (A) of FIG. 7, the VM manager calculates the hash value and subsequently instructs the memory controller to store the hash value in the hash value storage region. As illustrated in (B) of FIG. 7, the memory controller instructs the memory module to store the hash value. The memory module stores the hash value.

At a different timing from the hash value calculation process described above, the memory controller instructs the memory module to reread the data from the memory for the scrubbing process as illustrated in (B) of FIG. 7. As illustrated in (C) of FIG. 7, the memory module rereads the data and outputs the data to the memory controller. When the read data is input to the memory controller, an error detection and correction device that is provided inside the memory controller executes the error detection and correction processes as illustrated in (B) of FIG. 7. When there is a correctable error, the memory controller instructs the memory module to write back the corrected data. The corrected data is written back to the memory.

As described above, in the related art, the scanning of the memory in order to calculate the hash values of each page, and the scanning of the memory in order to carry out the scrubbing process of the memory are performed with no relation to each other. Therefore, the data is read in order to calculate the hash value, and, from the same memory element of the memory, the data is reread in order to carry out the scrubbing process of the memory at a different timing from the earlier reading.

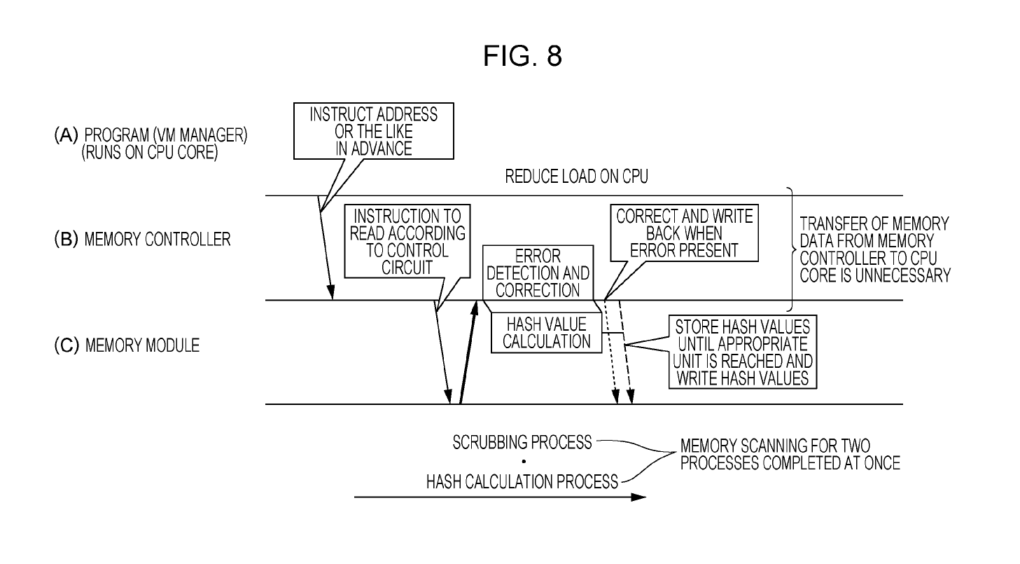

Meanwhile, in the first embodiment, as illustrated in (A) of FIG. 8, when the VM manager running on the CPU 16 specifies an address, the memory controller 18 instructs the reading of data from the memory in order to carry out the scrubbing process and the hash value calculation process, as illustrated in (B) of FIG. 8. As illustrated in (C) of FIG. 8, the memory module 14 reads data from the memory, and outputs the read data to the memory controller 18. As illustrated in (B) of FIG. 8, the scrubbing process and the hash value calculation process are executed by the memory controller 18. In other words, when a correctable error is present in the data read from the memory, the memory controller 18 corrects the error and writes the corrected data back to the memory. The memory controller 18 calculates the hash value of one page using the corrected data which is read for the scrubbing process and on which the error detection and correction process is executed, and stores the hash value in the memory.

In the related art, as illustrated in (A) of FIG. 7, the VM manager running on the CPU calculates the hash value. In contrast, in the first embodiment, the hash value calculation circuit 34 is provided in the memory controller 18. The hash value calculation circuit 34 calculates the hash values of each page using the data that is read from the memory for the scrubbing process, that is, without rereading the same data from the memory for the hash value calculation. In this manner, since the hash value calculation circuit 34 which is provided separately from the CPU 16 calculates the hash value using the memory scrubbing function ordinarily provided in the memory controller 18, it is possible to reduce the load on the CPU 16 when calculating the hash value for each page. Therefore, it may be possible to keep the execution of the main process of the CPU 16 from being impeded due to the calculation of the hash value.

### Second Effect

Since the calculation of the hash values performed using a combination of logical functions such as EOR and AND, and shifting, it is possible to realize the hash value calculation circuit 34 using simple hardware. Accordingly, in the first embodiment, by adding a small number of circuits to the memory controller 18, it is possible to reduce the load on the CPU 16 by an amount corresponding to the calculation of the hash values.

### Third Effect

In the first embodiment, when the control circuit 20 is in the idle state in which the CPU 16 does not execute the main processes, the control circuit 20 executes the scrubbing process and the hash value calculation process, and the process of writing the hash values to the memory. Accordingly, in comparison to the related art, in the first embodiment, it is possible to reduce the occurrence of a state in which the execution time of the process in which data is read from the memory in order to carry out the main processes of the CPU 16 is lengthened.

### Fourth Effect

In the related art, since the calculation of the hash values is performed by the CPU, the data have to be moved from the memory module to the CPU. However, in the first embodiment, as illustrated in FIG. 1, the hash value calculation circuit 34 and the storage buffer 36 are disposed in a position that is physically closer to the memory module 14 than the CPU 16. Accordingly, in the first embodiment, in order to calculate the hash values, it is sufficient to move the data from the memory module 14 to a position that is closer than the CPU 16 without moving the data to the CPU 16. Therefore, the first embodiment may suppress power consumption in comparison to the related art.

### Fifth Effect

As described in the first effect, in the first embodiment, the calculation of the hash values of each page is performed using the data that is read from the memory in order to carry out the scrubbing process. Therefore, scanning the target region of the memory once may be sufficient. Accordingly, in the first embodiment, it is possible to reduce the power consumption in the scrubbing process and the hash value calculation process in comparison to the example illustrated in FIG. 7.

Next, description will be given of a modification example of the first embodiment.

### First Modification Example

In the first modification example. The memory controller 18 is provided with a micro-processing unit (MPU) instead of the control circuit 20. In the first modification example, at least one of the error detection and correction circuit 30 and the hash value calculation circuit 34 is omitted. In the first modification example, at least one of the error detection and correction process and the calculation of the hash values is executed by the MPU according to a program, corresponding to the omission of at least one of the error detection and correction circuit 30 and the hash value calculation circuit 34.

In addition to the first to the fifth effects of the first embodiment, the first modification example has the effect of it being possible to render the configuration of the memory controller 18 simpler than in the first embodiment due to at least one of the error detection and correction circuit 30 and the hash value calculation circuit 34 being omitted.

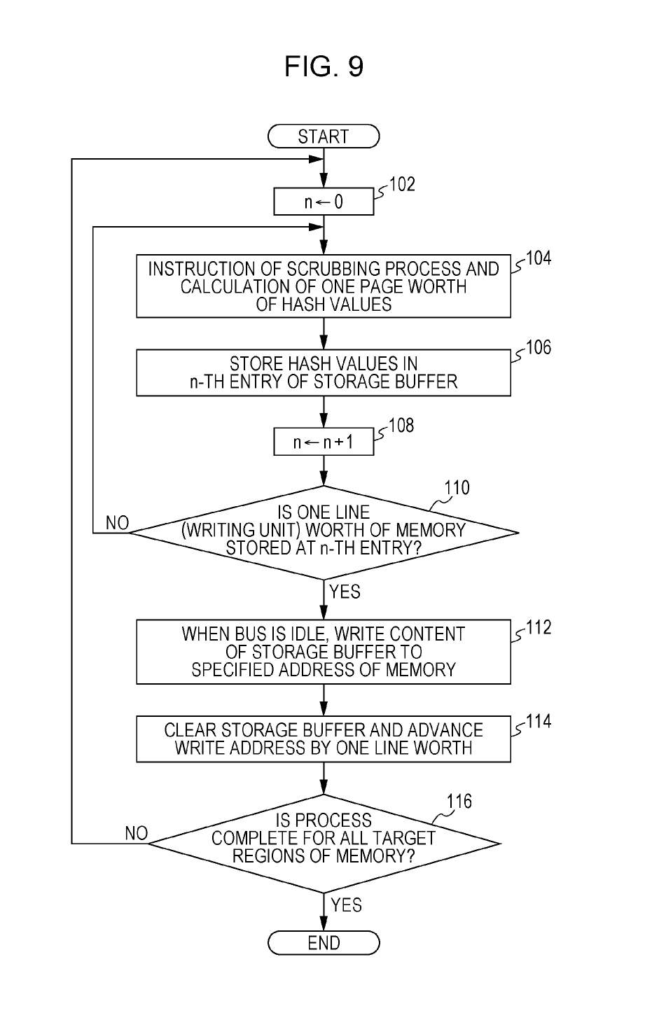

Hereinafter, description will be given of an example in which the error detection and correction circuit 30 is used while the hash value calculation circuit 34 is omitted, the corrected data is input to the MPU after the error detection and correction process, and the calculation of the hash values is executed by the MPU according to a program. Note that, the data processing program is stored in a ROM provided in the MPU. The MPU reads the program from the ROM and executed the following processes. In FIG. 9, an example of the data processing executed by the MPU is illustrated as a flowchart. As illustrated in FIG. 9, in step 102, the MPU initializes a variable n that identifies a region (an entry) in the storage buffer 36 in which the hash value is stored to 0. In step 104, the MPU controls each element to execute the scrubbing process in the manner described above, and calculates one page of hash values based on the corrected data that is obtained with the execution of the scrubbing process. In step 106, the MPU stores the hash values that are calculated in step 104 in the n-th entry of the storage buffer 36.

In step 108, the MPU increments the variable n by 1, and in step 110, the MPU determines whether or not one line (unit written to the memory) of memory is stored based on the entry that is identified by the variable n. When the determination results of step 110 are determined to be negative, the data processing returns to step 104, and the MPU executes the processes described above (step 104 to step 110). When the determination results of step 110 are determined to be positive, the data processing proceeds to step 112. In step 112, when the bus to the memory module 14 is in the idle state, the MPU writes the plurality of hash values of one line of memory stored in the storage buffer 36 to the specified address region of the memory.

In step 114, the MPU clears the storage buffer 36 and advances the write address of the memory by one line. In step 116, the MPU determines whether or not the process is complete for all target regions of the memory scrubbing process, based on the write address of the memory. When the determination results of step 116 are determined to be negative, the data processing returns to step 102, and the MPU executes the processes described above (step 102 to step 116). When the determination results of step 116 are determined to be positive, the data processing completes.

In the example described above, in addition to the first to the fifth effects of the first embodiment, since the hash value calculation circuit 34 is omitted, it is possible to render the configuration of the memory controller 18 simpler than that of the memory controller 18 of the first embodiment.

### Second Modification Example

In the first embodiment and the first modification example, the scrubbing process is executed on the entire region of the data storage region 14A. In the second modification example, the scrubbing process is executed on, first, a selected region not the entire region of the data storage region 14A, and second, the hash value storage region 14B. In the first case, the scrubbing process is executed only on desired locations, and in the second case, it is possible to correct errors in the data of the hash value storage region 14B.

### Third Modification Example

The method of calculating the hash values in the first embodiment is one example, and in the third modification example, the digest value is calculated using a method of calculation in which it is possible to obtain hash values that correspond to the content of the data of each page and provide a digest the content, the method being a method other than that of the example described above. For example, it is possible to apply a Bob Jenkins function, the message digest algorithm 5 (MD5), secure hash algorithm (SHA)-1 or the like.

### Fourth Modification Example

The first embodiment is described using memory sharing between VMs as an example. The fourth modification example supports page deduplication in virtual memory of an ordinary operating system (OS).

### Other Modification Examples

In the first embodiment, the number of data of one page is an integer multiple of the data of one line of memory, or an integer multiple of the data of a total of four of the ⅛ of the data of one line (refer to A, B, C, and D described above); however, the number may not be an integer multiple.

In the first embodiment, when the hash values of each page are calculated, the data from the error detection and correction circuit 30 is input to the hash value calculation circuit 34. In other words, the hash value calculation circuit 34 calculates the hash values of each page using the data from the error detection and correction circuit 30 as it is. In the disclosed technology, the calculation of the hash values of each page may be calculated using the data that is read from the memory before the data is input to the error detection and correction circuit 30, instead of using the data from the error detection and correction circuit 30. In this case, even if there is an error in the data that is temporarily read from the memory, generally, the hash value is different from the original value, and either a page which may be shared is not shared or a page which originally may not be shared is rendered a candidate for sharing; however, even in the latter case, since rechecking is performed before actual use, while there is a likelihood that extra processing is performed and the performance is reduced, no logical conflict occurs. Rarely, it is possible that the hash value of the error data and the hash value after error correction are the same; however, no problem occurs in this case.

In the first embodiment, description is given of a case in which the data that is read for the scrubbing process is used in the calculation of the hash values; however the embodiment is not limited thereto. In the same manner as a case in which the hash values are calculated for each page, the same effects may be obtained as in the first embodiment by using a process that is called by a process including reading the data stored in the memory sequentially for each predetermined unit in address order.

Furthermore, the hash value calculation control circuit 24, the hash value calculation circuit 34, the storage buffer 36, and the second selector 38 may be disposed outside of the memory controller 18.

The hash value calculation circuit 34 and the storage buffer 36 are disposed in a position that is physically closer to the memory module 14 than the CPU 16. However, the movement distance of the data between at least one of the hash value calculation circuit 34 and the storage buffer 36 and the memory module 14 may be longer than the movement distance of the data between the CPU 16 and the memory module 14.

### Second Embodiment

Next, description will be given of the second embodiment. The configuration of the data processing device 10 of the second embodiment is substantially the same as that of the data processing device 10 of the first embodiment. Therefore, hereinafter, description will be given of only the portions of the configuration of the data processing device 10 of the second embodiment that differ from those of the first embodiment, the portions of the configuration that are the same as in the first embodiment will be assigned the same reference numerals, and description thereof will be omitted.

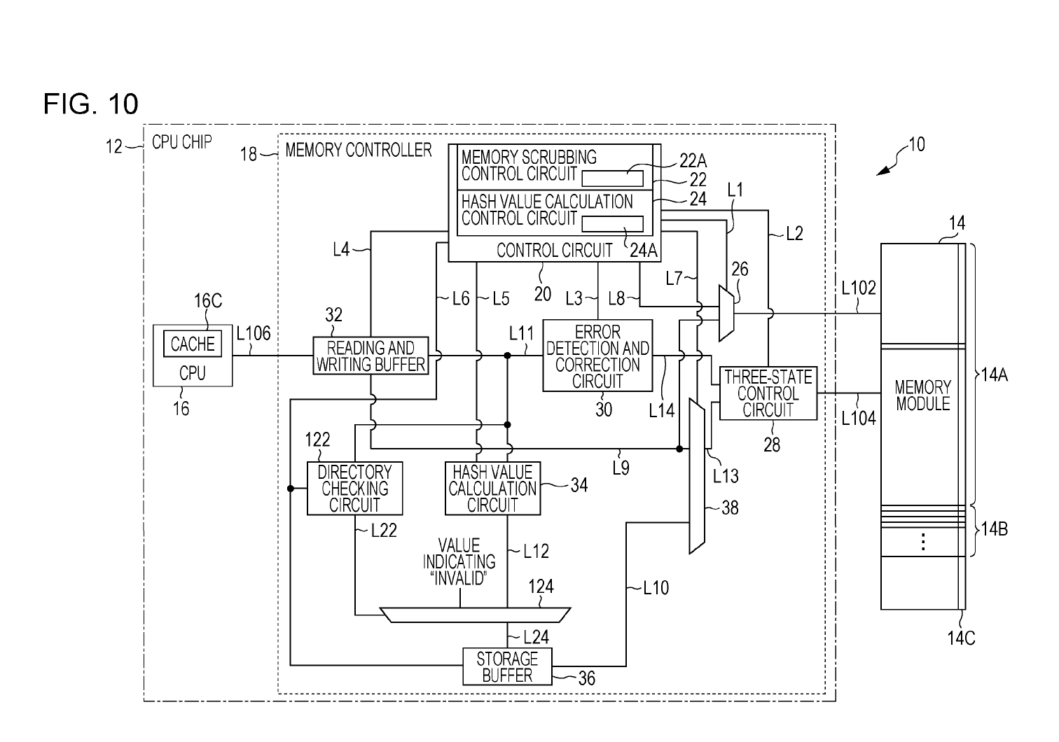

FIG. 10 illustrates a block diagram of the data processing device 10 of the second embodiment. As illustrated in FIG. 10, the CPU 16 is provided with a cache 16C. A directory information storage region 14C is provided in the memory. The directory information storage region 14C stores directory information (described later) corresponding to each line in relation to addresses of data in the line.

The memory controller 18 is further provided with a directory checking circuit 122 and a third selector 124. The data transmission line L11 from the error detection and correction circuit 30 is also connected to the input terminal of the directory checking circuit 122. The output terminal of the directory checking circuit 122 is connected to the input terminal that inputs the control signal of the third selector 124 via the control line L22. The data transmission line L12 that is connected to the output terminal of the hash value calculation circuit 34 is connected to one of the two input terminals of the third selector 124. A value indicating invalid (for example all bits are 0) is input to the other input terminal of the third selector 124. The control line L6 for transmitting a signal instructing the storage of a hash value from the hash value calculation control circuit 24 is also connected to the directory checking circuit 122.

Next, description will be given of the operations of the data processing device 10 of the second embodiment. The operations of the data processing device 10 of the second embodiment are substantially the same as those of the data processing device 10 of the first embodiment. Therefore, hereinafter, description will be given of, mainly, only the portions of the operations of the data processing device 10 of the second embodiment that differ from those of the first embodiment.

In the second embodiment, the cache 16C of the CPU 16 is write back type cache. In other words, in the write back type cache, when data is newly written to the memory, first, the data is written to the cache 16C, and the data is not transferred to the memory module 14. When a region for writing new data in the cache 16C is depleted or the like, of the cache lines that are written to the cache 16C, the data of cache lines which are used few times by the CPU 16, for example, is written back to the memory. Accordingly, at the stage at which the data to be written newly to the memory is written to the cache 16C, the new data is only present in the cache 16C and is not written to the memory.

Therefore, at this stage, when the hash values of each page are calculated using the data that is read from the memory, the hash values of the pages containing the new data that is stored in the cache 16C are calculated based on the old data that is not yet rewritten. Accordingly, there is a case in which a page that originally does not match due to the new data matches another page by chance due to the hash values based on the old data being referenced, and the originally non-matching page becomes a candidate for a page that is shared by a plurality of VMs (hereinafter, referred to as a “sharing candidate”). The second embodiment handles such a case in which, due to the cache 16C being of the write back type, a page that does not originally match becomes a sharing candidate of a plurality of VMs.

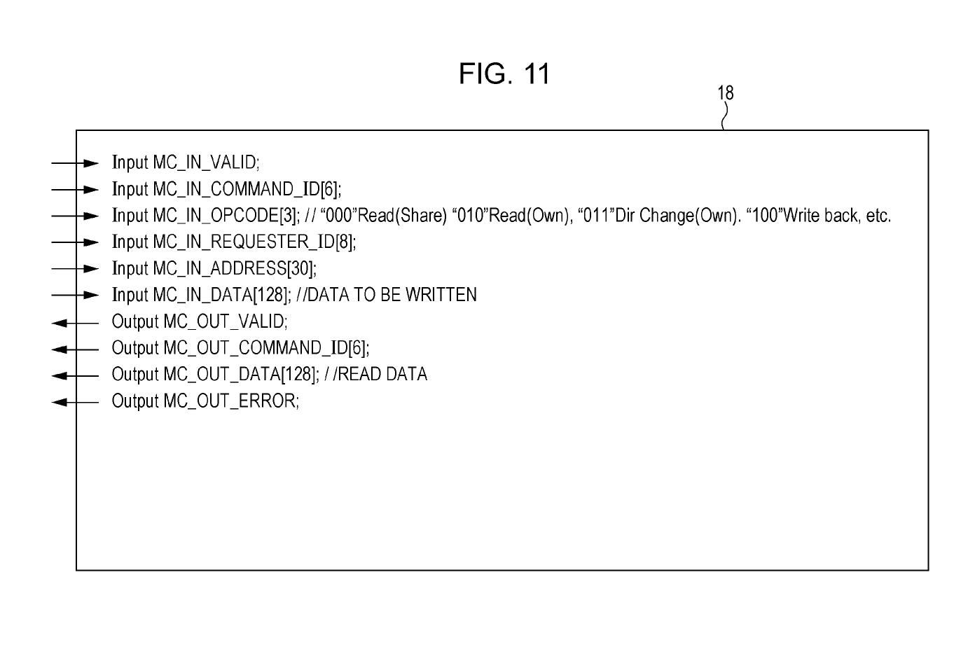

FIG. 11 illustrates the content of data that is input and output between the CPU 16 and the memory controller 18. As illustrated in FIG. 11, the following data is input to the memory controller 18 from the CPU 16. The data includes MC_IN_VALID, MC_IN_COMMAND_ID, MC_IN_OPCODE, MC_IN_REQUESTER_ID, MC_IN_ADDRESS, and MC_IN_DATA. The numbers within brackets indicate the number of lines of a portion of the data transmission line L106. MC_IN_OPCODE is a code indicating the specific content of a command from the CPU 16, and may be 000, 010, 011, 111, or the like.

In the example of FIG. 11, “000” is (Read(Share)), which indicates that data will simply be read from the memory. “100” is (Write back), which indicates that data is returned to the memory controller 18. “010” is (Read(Own)), which indicates reading in order to use data exclusively. In this case, the data that is written back to the memory may be modified. “011” also indicates reading in order to use data exclusively. However, the data itself is already held in a non-exclusive manner by the CPU 16, which is the request source, and “011” is (Dir Change (Own)), which indicates that the data that is read from the memory does not have to be transferred to the CPU 16.

The directory information is determined according to the content of MC_IN_OPCODE and MC_IN_REQUESTER_ID. MC_IN_ADDRESS indicates the address at which the data the CPU 16 is to process is stored. The control circuit 20 controls the memory module 14 such that the directory information according to MC_IN_OPCODE and MC_IN_REQUESTER_ID is stored in the directory information storage region 14C corresponding to the address specified by MC_IN_ADDRESS.

Note that, MC_OUT_VALID, MC_OUT_COMMAND_ID, MC_OUT_DATA, and MC_OUT_ERROR are output from the memory controller 18 to the CPU 16.

When the data of each line is read from the memory for the scrubbing process and the hash value calculation, the content of the directory information storage region 14C is also read. From among the data that is subjected to the error detection and correction by the error detection and correction circuit 30, the directory information of the directory information storage region 14C is input to the directory checking circuit 122. The directory checking circuit 122 controls the third selector 124 according to the content of the directory information that is input. The directory checking circuit 122 may check whether or not data that may be rewritten is contained in one page for which the hash value is calculated by the hash value calculation circuit 34. The hash value calculation circuit 34 calculates the hash value of a page that contains data that may be rewritten based on old data that is not yet rewritten. Accordingly, the hash value is stored in the storage buffer 36, and when the hash value is stored in the hash value storage region 14B, there is a case in which the hash value matches the hash value of another page by chance and becomes a sharing candidate of a plurality of VMs.

In order to avoid the situation, first, the hash value calculation control circuit 24 inputs an instruction signal to store the hash value to the directory checking circuit 122. The directory checking circuit 122 to which the instruction signal is input outputs a signal for causing the third selector 124 to select a value indicating invalid to the third selector 124. Accordingly, the third selector 124 outputs the value indicating invalid to the storage buffer 36. The storage buffer 36 to which the signal instructing the storage of the hash value from the hash value calculation control circuit 24 is input stores the value indicating invalid from the third selector 124 as the hash value of the page. The hash value, which is the value indicating invalid that is stored in the storage buffer 36 is stored in the hash value storage region 14B corresponding to the page.

Note that, when data that may be rewritten is not contained in the one page for which the hash value calculation circuit 34 calculates the hash value, the directory checking circuit 122 controls the third selector 124 to select the hash value from the error detection and correction circuit 30.

The hash value calculation circuit 34, the directory checking circuit 122, and the third selector 124 in the second embodiment are an example of the “determination unit” of the disclosed technology.

Next, description will be given of the effects of the second embodiment.

### First Effect

As described above, when the data of each line is read from the memory for the scrubbing process and the hash value calculation, the directory information that is stored in the directory information storage region 14C is also read. From among the data that is subjected to the error detection and correction by the error detection and correction circuit 30, the directory information that is stored in the directory information storage region 14C is input to the directory checking circuit 122. There is a case in which the hash value calculation circuit 34 calculates the hash value of a page that contains data that may be rewritten based on old data. In this case, the directory checking circuit 122 causes the third selector 124 to output the value indicating invalid instead of the hash value to the storage buffer 36. The hash value, which is the value indicating invalid that is stored in the storage buffer 36 is stored in the hash value storage region 14B corresponding to the page. The hash value which is the value indicating invalid is, for example, is a unique value in which all the bits are 0, and is distinct from a hash value based on ordinary data. Accordingly, the content of the page of the hash value which is a value indicating invalid is determined to be different from the content of a page of a hash value based on ordinary data. Accordingly, it may be possible to keep a page that does not originally match from becoming a sharing candidate of a plurality of VMs due to the cache 16C being of the write back type.

### Other Effects

The second embodiment has the same effects as the first to the fifth effects in the first embodiment.

Next, description will be given of a modification example of the second embodiment.

### First Modification Example

In the first modification example, in the same manner as in the first modification example of the first embodiment, the memory controller 18 is provided with an MPU instead of the control circuit 20. At least one of the error detection and correction circuit 30 and the hash value calculation circuit 34 is omitted. In the first modification example, at least one of the error detection and correction process and the calculation of the hash values is executed by the MPU according to a program, corresponding to the omission of at least one of the error detection and correction circuit 30 and the hash value calculation circuit 34.

In the first modification example, in addition to the first to the fifth effects of the first embodiment, it is possible to render the configuration of the memory controller 18 simpler than that of the memory controller 18 of the second embodiment.

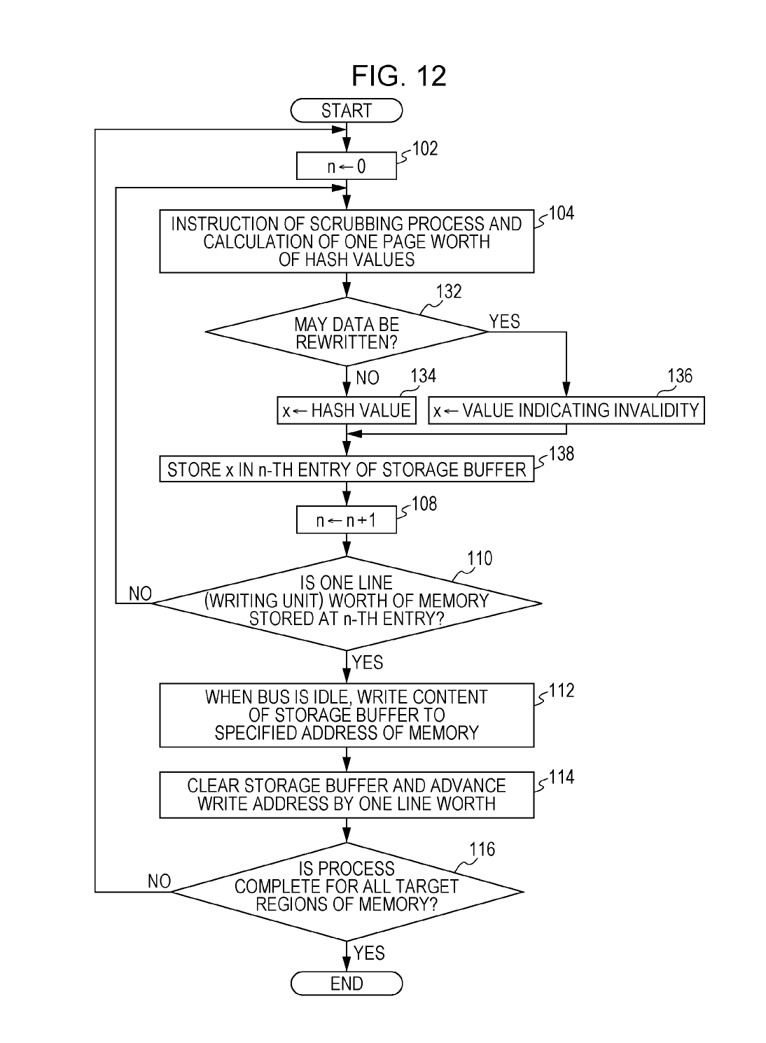

Hereinafter, description will be given of an example in which the error detection and correction circuit 30 is used while the hash value calculation circuit 34, the directory checking circuit 122, and the third selector 124 are omitted, the corrected data is input to the MPU after the error detection and correction process. In the present example, the MPU executes the calculation of the hash value according to a program. Note that, the data processing program is stored in a ROM provided in the MPU. The MPU reads the program from the ROM and executed the following processes. FIG. 12 illustrates a flowchart illustrating an example of data processing executed by the MPU instead of the control circuit 20 in the modification example of the second embodiment. Note that, since the data processing executed by the MPU illustrated in FIG. 12 is substantially the same as the processes illustrated in FIG. 9, the same steps will be assigned the same reference numerals, description thereof will be omitted, and description will be given only of the different steps.

After step 104, the data processing proceeds to step 132. In step 132, when the MPU calculates one page of hash values in step 104 based on the directory information of each of all the lines used in the calculation in step 104, the MPU determines whether or not the page contains data that may be rewritten.

When the determination results of step 104 are determined to be negative, in step 134, the MPU sets x to the hash value that is calculated in step 104. Meanwhile, when the determination results of step 104 are determined to be positive, in step 136, the MPU sets x to a value indicating invalid.

In step 138, the value that x is set to is stored in the n-th entry of the storage buffer 36.

In the example described above, in addition to the first to the fourth effects of the second embodiment, since the hash value calculation circuit 34 is omitted, it is possible to render the configuration of the memory controller 18 simpler than that of the memory controller 18 of the second embodiment.

### Second Modification Example

The configuration of the data processing device 10 of the second modification example is substantially the same as that of the data processing device 10 of the second embodiment. Therefore, hereinafter, description will be given of, mainly, only the portions of the configuration of the data processing device 10 of the second modification example that differ from those of the second embodiment, the portions of the configuration that are the same as in the second embodiment will be assigned the same reference numerals, and description thereof will be omitted.

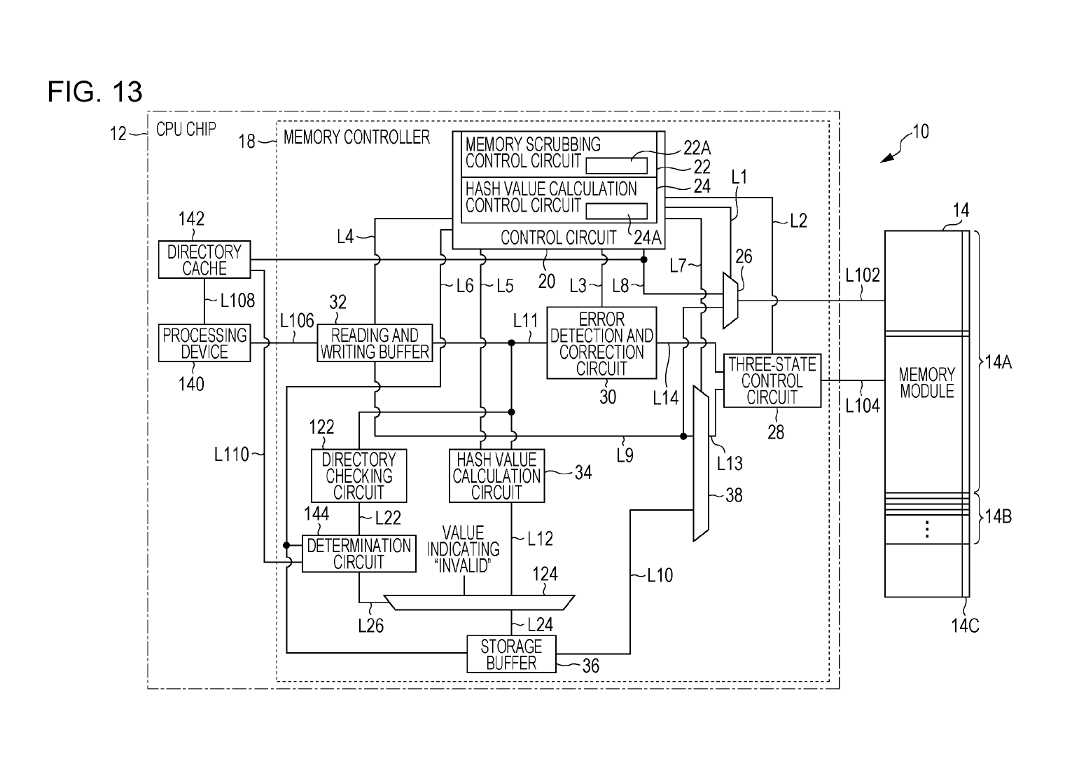

FIG. 13 illustrates a block diagram of the data processing device 10 of the second modification example of the second embodiment. As illustrated in FIG. 13, the CPU chip 12 is provided with a processing device 140 and a directory cache 142. The directory cache 142 is of the write back type. The processing device 140 is provided with the CPU 16 that is provided with the cache 16C of the second embodiment, and a system controller that executes processes including the management of the directory cache 142. The memory controller 18 is provided with a determination circuit 144 that is provided between the directory checking circuit 122 and the third selector 124. The data transmission line L8 that is connected to the output terminal of the control circuit 20 is also connected to the directory cache 142. The directory cache 142 is connected to the processing device 140 via a signal line group L108. The output terminal of the directory cache 142 is connected to the first input terminal of the first to the third input terminals of the determination circuit 144 via the data transmission line L110. Unlike in the example in the second embodiment (refer to FIG. 10), the control line L6 from the hash value calculation control circuit 24 is connected to the second input terminal of the determination circuit 144 without being connected to the directory checking circuit 122. The third input terminal of the determination circuit 144 is connected to the output terminal of the directory checking circuit 122 via the data transmission line L22. The output terminal of the determination circuit 144 is connected to the input terminal of the third selector 124 via the control line L26, the input terminal of the third selector 124 being for the input of the control signal.

Next, description will be given of the operations of the data processing device 10 of the second modification example. The operations of the data processing device 10 of the second modification example are substantially the same as those of the data processing device 10 of the second embodiment. Therefore, hereinafter, description will be given of, mainly, only the portions of the operations of the data processing device 10 of the second modification example that differ from those of the second embodiment.

The system controller of the processing device 140 ascertains the directory information indicating that the data may be rewritten based on the content of MC_IN_OPCODE. The system controller stores the ascertained directory information in the directory cache 142 according to the address indicated by MC_IN_ADDRESS.

However, the directory cache 142 does not have a substantially large storage capacity. Accordingly, when a region for writing new data in the directory cache 142 is depleted or the like, the processing device 140 instructs the memory controller 18 to store, for example, the directory information which is used few times by the CPU 16 in the directory information storage region 14C.

Here, the directory information that is stored in the directory information storage region 14C has the same content until the directory information is newly written. Accordingly, when the directory information is stored in the directory cache 142, the directory information that is stored in the directory information storage region 14C is older than the content of the directory cache 142. Accordingly, when the directory information is stored in the directory cache 142, the directory information of the directory cache 142 is prioritized over the content of the directory information storage region 14C. Therefore, in the second modification example, a signal indicating that the directory information of the directory cache 142 is prioritized over the content of the directory information storage region 14C is input to the determination circuit 144 from the directory cache 142.

When the data of each line is read from the memory for the scrubbing process and the hash value calculation, the content of the directory information storage region 14C is also read. From among the data that is subjected to the error detection and correction process by the error detection and correction circuit 30, the content of the directory information storage region 14C is input to the directory checking circuit 122.

When the directory information indicating that there is a likelihood of rewriting is present in the directory information storage region 14C, the directory checking circuit 122 outputs a signal instructing the selection of a value indicating invalid to the determination circuit 144. However, when the directory information indicating that there is a likelihood of rewriting is not present in the directory information storage region 14C, the directory checking circuit 122 does not output a signal instructing the selection of a value indicating invalid to the determination circuit 144.

The control circuit 20 also inputs the command and the address of the time at which the data of one line is read from the memory to the directory cache 142. When the directory information is present in the directory cache 142 corresponding to the address that is input from the control circuit 20, the directory cache 142 outputs a signal to the determination circuit 144. However, when the directory information corresponding to the data of the address that is input is not present in the directory cache 142, the directory cache 142 does not output a signal to the determination circuit 144.

When the signal is not input to the determination circuit 144 from the directory cache 142, the determination circuit 144 follows the instructions of the directory checking circuit 122. First, at the timing at which the hash value of the page containing that may be rewritten is output from the hash value calculation circuit 34, a signal is output from the control circuit 20 to the determination circuit 144. When a signal instructing the selection of a value indicating invalid is input from the directory checking circuit 122 to the determination circuit 144, the determination circuit 144 controls the third selector 124 to select the value indicating invalid at the timing at which a signal is input from the control circuit 20 to the determination circuit 144. When the instruction signal from the directory checking circuit 122 is not input to the determination circuit 144, the determination circuit 144 controls the third selector 124 to select the hash value from the hash value calculation circuit 34 at the timing at which a signal is input from the control circuit 20 to the determination circuit 144.

Meanwhile, when the signal is input to the determination circuit 144 from the directory cache 142, the determination circuit 144 does not follow the instructions of the directory checking circuit 122. In other words, the determination circuit 144 controls the third selector 124 at the timing at which a signal is input from the control circuit 20 to the determination circuit 144 regardless of whether or not the instruction signal is input to the determination circuit 144 from the directory checking circuit 122. Specifically, according to the directory information read from the directory cache 142, the determination circuit 144 controls the third selector 124 to select a value indicating invalid if the data may be rewritten, and to select the hash value from the hash value calculation circuit 34 if the data may not be rewritten.

The second modification example has the following effects in addition to the effects of the second embodiment.

As described above, when the data may be rewritten, the determination circuit 144 outputs a signal for instructing the third selector 124 to select the value indicating invalid regardless of the content of the hash value storage region 14B. Accordingly, in the second modification example, even if the directory cache 142 is provided, it may be possible to keep a page that does not originally match from becoming a sharing candidate of a plurality of VMs due to the cache 16C being of the write back type.

Note that, in the second modification example, as in the first modification example of the second embodiment, when the MPU is provided instead of the control circuit 20, in the process indicated in FIG. 12, when the determination result of step 132 is determined to be negative, the MPU executes the next step. First, the MPU determines whether or not the directory information is present in the directory cache 142. When the MPU determines that the directory information is not present in the directory cache 142, if the data may be rewritten according to the directory information that is read from the memory, the data processing proceeds to step 136. Meanwhile, if the data may not be rewritten, the data processing proceeds to step 134. When the MPU determines that the directory information is present in the directory cache 142, the MPU follows the information that is read from the directory cache 142 instead of the directory information that is read from the memory. In other words, in the same manner as described above, if the data may be rewritten, the data processing proceeds to step 136. Meanwhile, if the data may not be rewritten, the data processing proceeds to step 134.

The hash value calculation circuit 34, the directory checking circuit 122, the third selector 124, the directory cache 142, and the determination circuit 144 in the second embodiment are an example of the “determination unit” of the disclosed technology.

Note that, the second modification example, the third modification example, the fourth modification example, and the other modification examples in the first embodiment may be applied as modification examples of the second embodiment.

In the second embodiment, a case where the hash value of a page containing data that may be rewritten accidentally matches a hash value of another page and where a page that does not originally match becomes a sharing candidate of a plurality of VMs is avoided. Therefore, in the second embodiment, the hash value of a page containing data that may be rewritten is set to a value indicating invalid. If the hash value is a value indicating invalid, the page corresponding to the hash value is determined to be a page containing data that may be rewritten. If the page may be determined to be a page containing data that may be rewritten, it may be possible to keep a page that does not originally match from becoming a sharing candidate of a plurality of VMs.

Note that, depending on the hash function, there is a case in which a predetermined “value indicating invalid” is coincidentally generated as a valid value by the calculation of the hash value. A page for which such a hash value is calculated is excluded from being a sharing candidate. However, when, for example, a hash function which calculates a 32 bit value as the hash value is used, assuming that the hash values are appropriately distributed, the probability that a valid hash value becomes the “value indicating invalid” is 2⁻³² (about 1 in 4.3×10⁹). For example, when a hash function that calculates a 64 bit value as the hash value is used, the probability is approximately 1 in 1.845×10¹⁹. Therefore, even if the hash value of a page containing data which may be rewritten is used as the “value indicating invalid”, since the likelihood of a case in which such a page is excluded from being a sharing candidate occurring is substantially insignificant, a problem is not posed. In other words, even if a value that may be computed using an ordinary calculation in a predetermined hash function is defined as the “value indicating invalid”, there is no problem.

### Third Embodiment

Next, description will be given of the third embodiment. The configuration of the data processing device 10 of the third embodiment is substantially the same as that of the data processing device 10 of the first embodiment. Therefore, hereinafter, description will be given of only the portions of the configuration of the data processing device 10 of the third embodiment that differ from those of the first embodiment, the portions of the configuration that are the same as in the first embodiment will be assigned the same reference numerals, and description thereof will be omitted.

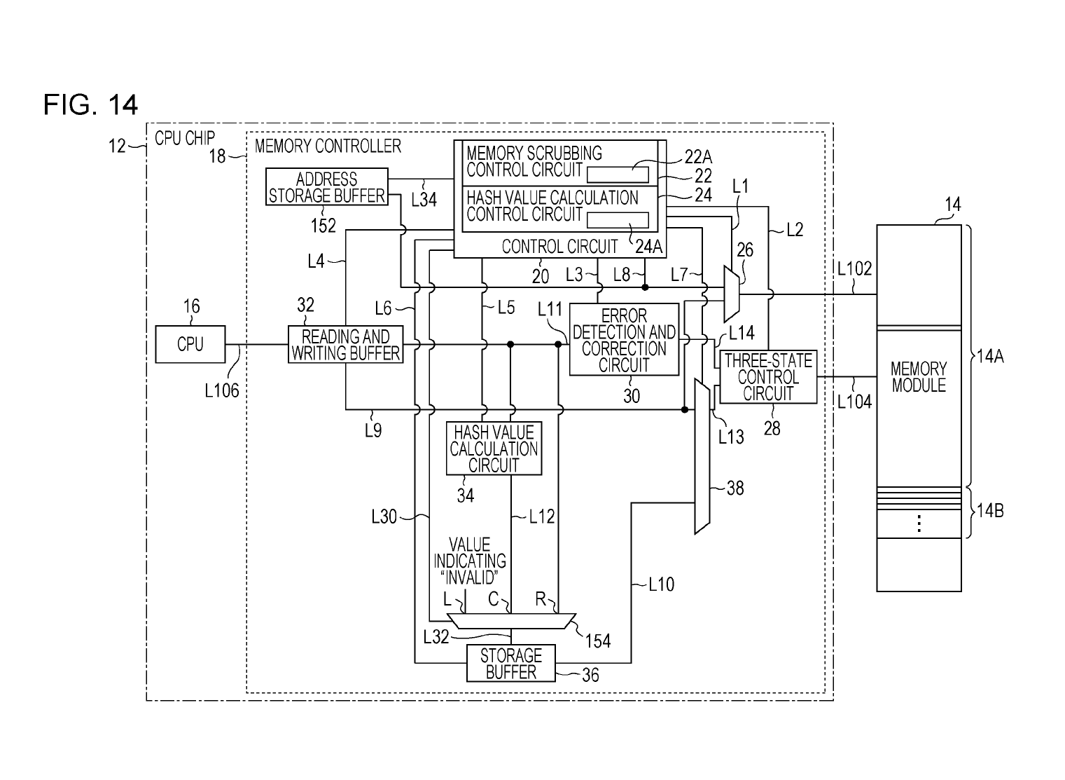

FIG. 14 illustrates a block diagram of the data processing device 10 of the third embodiment. As illustrated in FIG. 14, the memory controller 18 is further provided with an address storage buffer 152 which is connected to the control circuit 20 and stores an address at which the rewriting of data occurs. The memory controller 18 is provided with a selector 154 between the hash value calculation circuit 34 and the storage buffer 36. The data transmission line L11 from the error detection and correction circuit 30 is connected to a first input terminal R of the selector 154. The output terminal of the hash value calculation circuit 34 is connected to a second input terminal C of the selector 154 via the data transmission line L12. The value indicating invalid is input to a third input terminal L of the selector 154. The control signal input terminal of the selector 154 is connected to the control circuit 20 via the control line L30. The output terminal of the selector 154 is connected to the storage buffer 36 via the data transmission line L32.

Next, description will be given of the operations of the data processing device 10 of the third embodiment. The operations of the data processing device 10 of the third embodiment are substantially the same as those of the data processing device 10 of the first embodiment. Hereinafter, description will be given of, mainly, only the portions of the operations of the data processing device 10 of the third embodiment that differ from those of the first embodiment.

Even in the third embodiment, the scrubbing process and the hash value calculation process in the first embodiment are executed. Note that, in the scrubbing process and the hash value calculation process, the control circuit 20 controls the selector 154 to select the input terminal C at the timing at which the hash value of each page from the hash value calculation circuit 34 is stored in the storage buffer 36.

However, in the second embodiment, a page containing data that may be rewritten is ascertained using the directory information. In contrast, in the third embodiment, a page containing data that may be rewritten is ascertained based on an address that is stored in the address storage buffer 152.

In the second embodiment, when reading the data from the memory in the scrubbing process, a value indicating invalid is stored in the hash value storage region 14B as the hash value of a page containing data that may be rewritten. In contrast, in the third embodiment, unrelated to the scrubbing process, when the data may be rewritten, the value indicating invalid is stored in the hash value storage region 14B as the hash value of a page containing the data which may be rewritten.

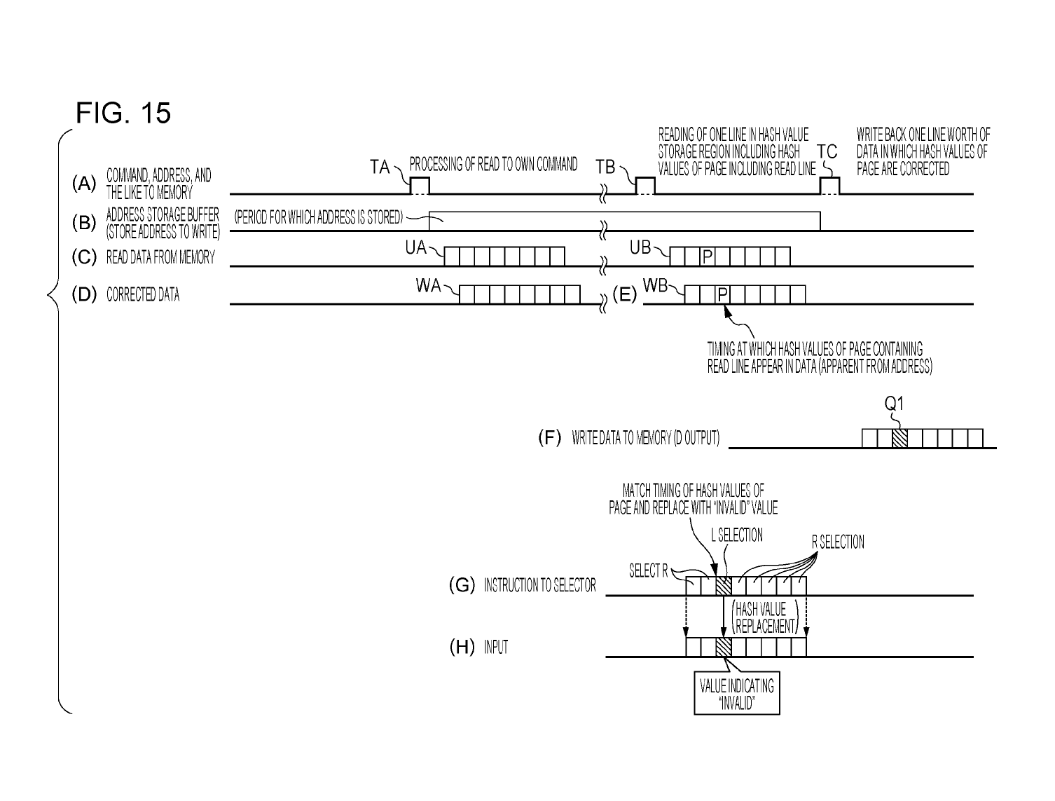

FIG. 15 illustrates a timing chart of operations including an operation in which the hash value is changed to the value indicating invalid in the control circuit 20 of the third embodiment.

When, for example, “010” (Read to Own) is output from the CPU 16 to the control circuit 20, the control circuit 20 outputs the command and the address to the memory module 14 as illustrated in (A) of FIG. 15 (refer to TA). As described above, since “010” indicates reading in order to use data exclusively, the command indicates reading.

As illustrated in (B) of FIG. 15, the control circuit 20 causes the address storage buffer 152 to store an address to which the data may be newly written at the next timing after a predetermined time until the instruction to write back data illustrated in (A) of FIG. 15 (refer to TC) is present.

The memory module 14 to which the command and the address are input outputs the data of one line containing the specified address to the memory controller 18 as illustrated in (C) of FIG. 15 (refer to UA). Accordingly, as illustrated in (D) of FIG. 15 (refer to WA), the corrected data is output from the error detection and correction circuit 30 to the reading and writing buffer 32 at the next timing after a predetermined time. Subsequently, the corrected data is output to the CPU 16.

Next, when the control circuit 20 is in the idle state, as illustrated in (A) of FIG. 15 (refer to TB), the control circuit 20 outputs the command and the address to the memory module 14. The address is the address of one line of the hash value storage region 14B, and is the address of one line containing a hash value of a page that contains data that may be rewritten.

The memory module 14 to which the command and the address are input outputs the data of one line (a plurality of hash values) containing the specified address to the memory controller 18 as illustrated in (C) of FIG. 15 (refer to UB). Accordingly, as illustrated in (E) of FIG. 15 (refer to WB), the data of one line (the plurality of hash values) is input to the input terminal R of the selector 154 from the error detection and correction circuit 30 at the next timing after a predetermined time. In (E) of FIG. 15, the timing at which, of the data of one line (the plurality of hash values), the hash value of a page containing data of an address to which data may be newly written is input to the input terminal R of the selector 154 is indicated by “P”.

The control circuit 20 controls the selector 154 to select the value from the input terminal R at the timing other than the timing indicated by “P” of the data of one line (the plurality of hash values) input to the input terminal R of the selector 154. Accordingly, at the timing other than the timing indicated by “P”, the selector 154 selects the hash value that is stored in the hash value storage region 14B. Meanwhile, the control circuit 20 controls the selector 154 to select the value from the input terminal L at a timing at which the hash value of a page containing the data of the address to which data may be newly written is input to the input terminal R of the selector 154. The value from the input terminal L is the value indicating invalid.

According to the above description, other than the pages containing, of the data of one line (the plurality of hash values), data of an address to which data may be newly written, the hash values stored in the hash value storage region 14B are stored in the storage buffer 36. In contrast, in relation to pages containing data of an address to which data may be newly written, the value indicating invalid is stored in the storage buffer 36 as the hash value. When the storage buffer 36 is instructed from the control circuit 20 to write back data as illustrated in (A) of FIG. 15 (refer to TC), the one line of data (the plurality of hash values) is written back to the one line of the original address as illustrated in (F) of FIG. 15. In relation to one line of data (the plurality of hash values) which is written back to the one line of the original address, the value indicating invalid is stored in the page containing data of an address to which data may be newly written as the hash value of the page (refer to Q1).

The address storage buffer 152, the selector 154, the storage buffer 36, the second selector 38, and the three-state control circuit 28 are an example of the “rewriting unit” of the disclosed technology.

Next, description will be given of the effects of the third embodiment.

### First Effect

Unrelated to the scrubbing process, the control circuit 20 of the third embodiment ascertains a page containing data that may be rewritten based on an address that is stored in the address storage buffer 152. The control circuit 20 stores the value indicating invalid as the hash value of the page in the hash value storage region 14B. Accordingly, it may be possible to keep a page that does not originally match from becoming a sharing candidate of a plurality of VMs.

### Other Effects

The third embodiment has the same effects as the first to the fifth effects in the first embodiment.

Next, description will be given of a modification example of the third embodiment.

In the modification example of the third embodiment, in the same manner as in the first modification example of the first embodiment, the memory controller 18 is provided with an MPU instead of the control circuit 20. In the modification example of the third embodiment, at least one of the error detection and correction circuit 30, the hash value calculation circuit 34, the selector 154, and the portion containing the line from the error detection and correction circuit 30 to the input terminal R of the selector 154 is omitted. Furthermore, in the modification example of the third embodiment, corresponding to the omission, at least one of the error detection and correction process and the calculation of the hash value is executed by the MPU according to a program. The modification example of the third embodiment has the same effects as the first modification example of the first embodiment.

Note that, the second modification example, the third modification example, the fourth modification example, and the other modification examples in the first embodiment may be applied as modification examples of the third embodiment.

### Fourth Embodiment

Next, description will be given of the fourth embodiment. The configuration of the data processing device 10 of the fourth embodiment is substantially the same as that of the data processing device 10 of the third embodiment. Therefore, hereinafter, description will be given of only the portions of the configuration of the data processing device 10 of the fourth embodiment that differ from those of the third embodiment, the portions of the configuration that are the same as in the third embodiment will be assigned the same reference numerals, and description thereof will be omitted.

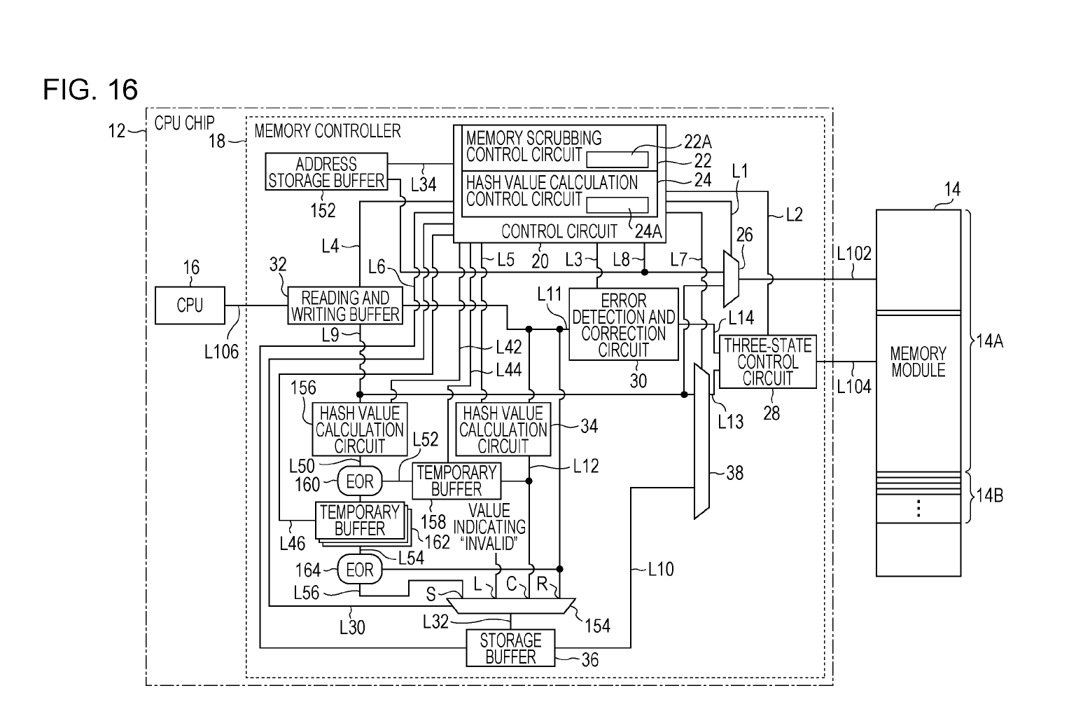

FIG. 16 illustrates a block diagram of the data processing device 10 of the fourth embodiment. As illustrated in FIG. 16, the memory controller 18 is provided with a hash value calculation circuit 156 which is separate from the hash value calculation circuit 34, a temporary buffer 158, a first EOR circuit 160, a plurality of temporary buffers 162, and a second EOR circuit 164.

The hash value calculation circuit 156 is connected to the reading and writing buffer 32 via the data transmission line L9, and is connected to the control circuit 20 via the control line L42. The output terminal of the hash value calculation circuit 34 is also connected to the input terminal of the temporary buffer 158. The output terminal of the temporary buffer 158 is connected to one of the two input terminals of the first EOR circuit 160. The temporary buffer 158 is connected to the control circuit 20 via a control line L44. The output terminal of the hash value calculation circuit 156 is connected to the other input terminal of the first EOR circuit 160 via a data transmission line L50. The output terminal of the first EOR circuit 160 is connected to each of the input terminals of the plurality of temporary buffers 162.

One of the two input terminals of the second EOR circuit 164 is connected to the data transmission line L11 that is connected to the output terminal of the error detection and correction circuit 30 and is connected to the input terminal R of the selector 154. Each of the output terminals of the plurality of temporary buffers 162 is connected to the other input terminal of the second EOR circuit 164. Each of the plurality of temporary buffers 162 is connected to the control circuit 20 via each of a plurality of control lines L46.

In the fourth embodiment, in addition to the input terminals R, C, and L, a separate input terminal S is provided in the selector 154. The output terminal of the second EOR circuit 164 is connected to the input terminal S of the selector 154 via the data transmission line L56.

Next, description will be given of the operations of the data processing device 10 of the fourth embodiment. The operations of the data processing device 10 of the fourth embodiment are substantially the same as those of the data processing device 10 of the third embodiment. Hereinafter, description will be given of, mainly, the portions of the operations of the data processing device 10 of the fourth embodiment that differ from those of the third embodiment. Even in the fourth embodiment, the scrubbing process and the hash value calculation process in the third embodiment are executed.

However, in the fourth embodiment, the writing of data to the memory is Read-modify-write. In detail, when the memory controller 18 receives data of a certain line from the CPU 16 to write to memory, the memory controller 18 does not write the received data to the memory as it is. In Read-modify-write, the data of the line is temporarily read from memory (read), and the content of the control information or the like (the directory information or the like) is tested. The read data is rewritten (modify) with the data received from the CPU 16 and written back to the memory (write). In the fourth embodiment, the hash value of one page containing data to be newly written is calculated as follows. The difference between the partial hash value based on the data containing the original data and the partial hash value based on the data containing the data to be newly written is applied to the hash value of the original one page. Accordingly, in the fourth embodiment, a hash function that may calculate a difference is used as the hash function for obtaining the hash value.

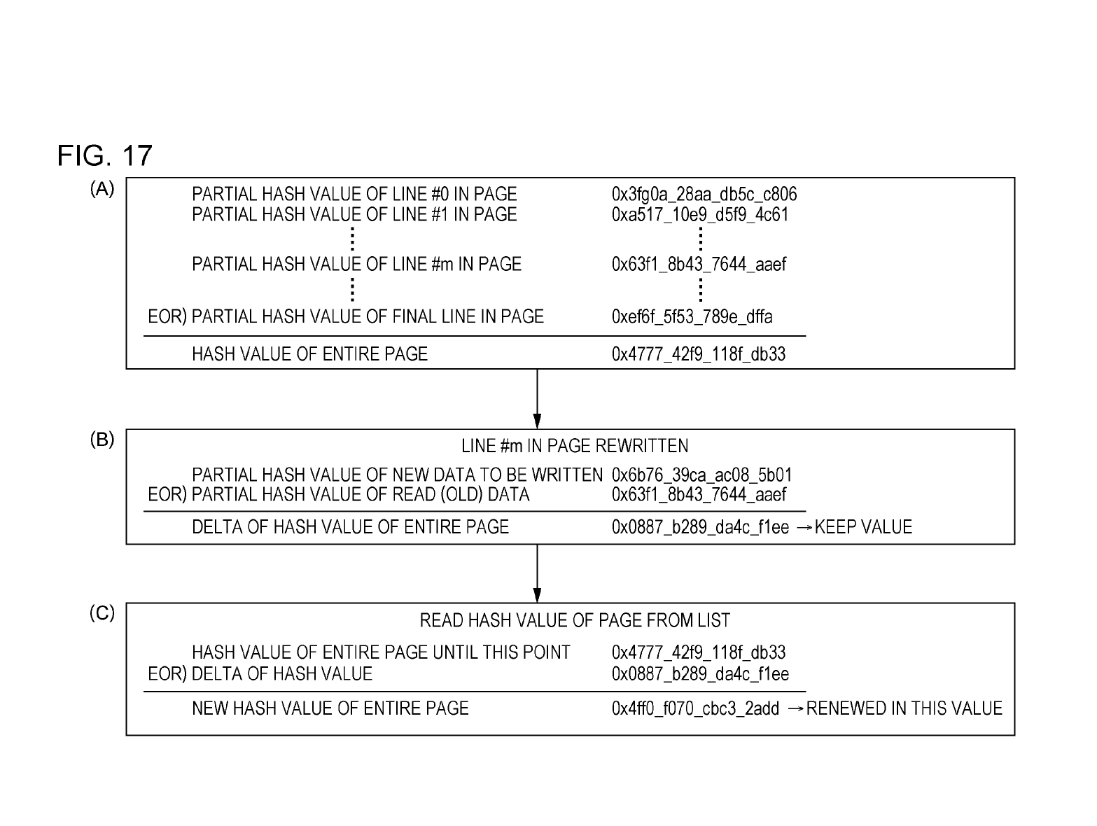

FIG. 17 illustrates the specific content in which a hash value is updated by calculating the difference of hash values. While detailed description will be given later, first, a general description will be given of the content in which the hash value is updated. The memory controller 18 calculates the hash value of one page as follows. As illustrated in (A) of FIG. 17, first, in relation to each of a plurality of lines (#0, #1, . . . final line), the memory controller 18 calculates the hash values (partial hash values) from a plurality of data. The memory controller 18 calculates the hash value of one page by calculating the EOR of the hash values of each line.

Next, for example, line #m is hypothetically rewritten with new data. The memory controller 18 calculates the hash value (the partial hash value) from the data of the new line #m. In relation to line #m, the memory controller 18 calculates the difference (EOR) between the partial hash value that is calculated from the new data, and the partial hash value that is calculates from the old data before rewriting (refer to (B) of FIG. 17).

As illustrated in (C) of FIG. 17, the memory controller 18 performs the calculation of updating the hash value of the page by calculating the EOR between the hash value of the entire page before rewriting and the difference of the partial hash value.

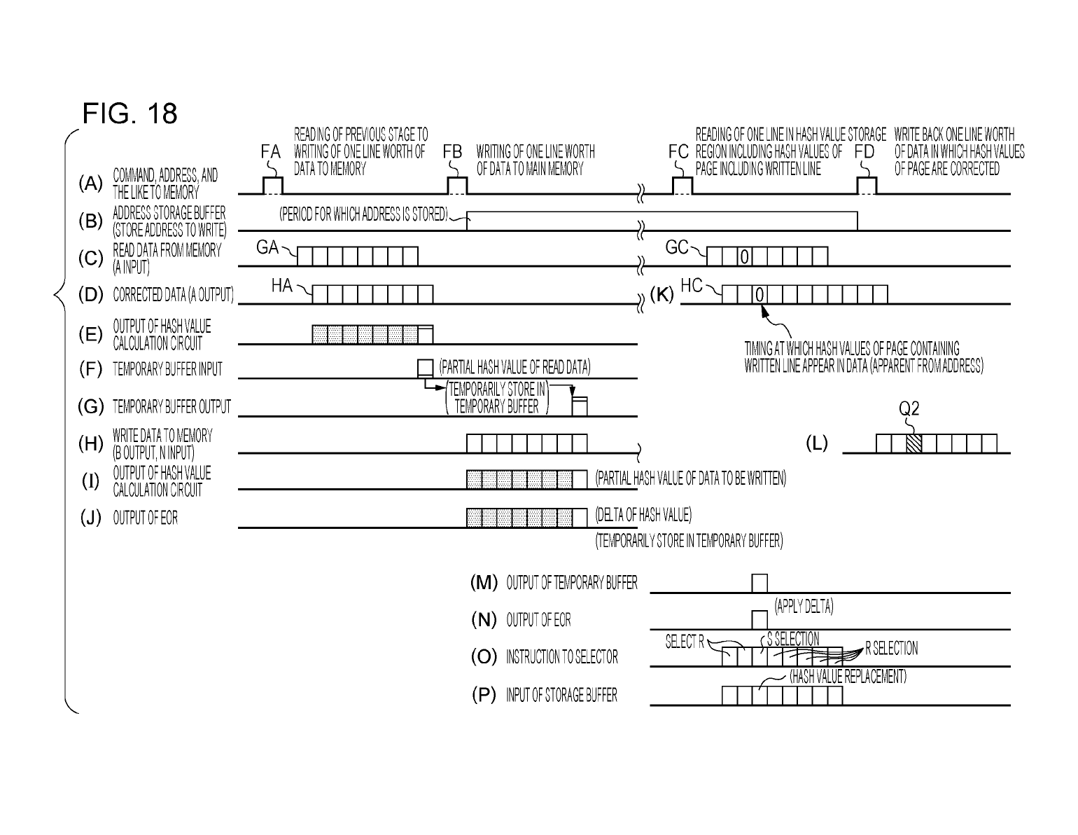

FIG. 18 illustrates a timing chart of operations of the control circuit 20 of the fourth embodiment including an operation in which the hash value is updated.

When the writing of one line of data to the memory is instructed from the CPU 16, since the memory controller 18 calculates the partial hash value of the one line of data before the data is written, the memory controller 18 reads the one line of data. In other words, as illustrated in (A) of FIG. 18 (refer to FA), the control circuit 20 outputs the address and the read command of the one line of data to the memory module 14. Subsequently, the memory module 14 reads the data of the specified line, and outputs the read data to the memory controller 18 as illustrated in (C) of FIG. 18 (refer to GA). The read data is input to the error detection and correction circuit 30. The corrected data from the error detection and correction circuit 30 is output to the hash value calculation circuit 34 as illustrated in (D) of FIG. 18 (refer to HA). The control circuit 20 controls the temporary buffer 158 to store the hash value from the hash value calculation circuit 34 as illustrated in (F) of FIG. 18 at the timing at which the hash value that is calculated based on the one line of data by the hash value calculation circuit 34 is output. The temporary buffer 158 outputs the hash value to the first EOR circuit 160.

When there is an instruction to write the new data of one line from the CPU 16, the control circuit 20 outputs the address and the read command of the one line of data to the memory module 14 as illustrated in (A) of FIG. 18 (refer to FB). As illustrated in (B) of FIG. 18, the address from the control circuit 20 to the storage buffer 36 is stored in the address storage buffer 152 until the writing back of the data illustrated in (A) of FIG. 18 (refer to FD) is instructed. The new data of the one line is temporarily stored in the reading and writing buffer 32 from the CPU 16, is output to the memory module 14 as illustrated in (H) of FIG. 18, and is output to the hash value calculation circuit 156 as illustrated in (I) of FIG. 18. The following processes are performed at the timing at which the hash value that is calculated by the hash value calculation circuit 156 based on the new data of the one line. In other words, as illustrated in (J) of FIG. 18, the first EOR circuit 160 calculates the difference between the hash value from the hash value calculation circuit 156 and the hash value from the temporary buffer 158. At this timing, the control circuit 20 performs control such that the difference that is output from the first EOR circuit 160 is stored in a specified one of the plurality of temporary buffers 162.

When the control circuit 20 is in the idle state, the control circuit 20 controls the memory module 14 to read the data of one line (the plurality of hash values) containing the hash value of one page containing the new data of the one line from the hash value storage region 14B (refer to FC in (A) of FIG. 18).

The memory module 14 reads the data of the specified line (the plurality of hash values), and outputs the read data to the memory controller 18 as illustrated in (C) of FIG. 18 (refer to GC). The data of the line (the plurality of hash values) is input to the error detection and correction circuit 30. The corrected data is output from the error detection and correction circuit 30 as illustrated in (K) of FIG. 18 (refer to HC). The corrected data is input to the input terminal R of the selector 154, and is also input to the second EOR circuit 164. In (K) of FIG. 18, the timing at which, of the data of one line (the plurality of hash values), the hash value of a page containing data of an address to which data is newly written is input to the input terminal R of the selector 154 is indicated by “P”.

As illustrated in (O) of FIG. 18, the control circuit 20 controls the selector 154 to select the value from the input terminal R at the timing other than the timing indicated by “P” of the data of one line (the plurality of hash values) input to the input terminal R of the selector 154. Accordingly, at the timing other than the timing indicated by “P”, the selector 154 selects the hash value that is stored in the hash value storage region 14B.

Meanwhile, the control circuit 20 applies the difference of the hash value that is held in the selected temporary buffer 162 to the original hash value at a timing at which the hash value of a page containing the data of the address to which data is newly written is input to the input terminal R of the selector 154. In other words, first, as illustrated in (M) of FIG. 18, the control circuit 20 causes the temporary buffer 162 that holds the difference of the hash value to output the difference. The second EOR circuit 164 calculates the EOR between the original hash value from the error detection and correction circuit 30 and the difference from the temporary buffer 162, and inputs the result to the input terminal S of the selector 154 as illustrated in (N) of FIG. 18. As illustrated in (O) of FIG. 18, the control circuit 20 controls the selector 154 to select the input terminal S at the timing at which the hash value of the page containing the data of the address to which data is newly written is input to the input terminal R of the selector 154.

According to the above description, as illustrated in (P) of FIG. 18, other than the pages containing, of the data of one line (the plurality of hash values), data of an address to which data is newly written, the hash values stored in the hash value storage region 14B are stored in the storage buffer 36. In contrast, in relation to pages containing data of an address to which data is newly written, the updated hash value is stored in the storage buffer 36. When the storage buffer 36 is instructed from the control circuit 20 to write back data as illustrated in (A) of FIG. 18 (refer to FD), the one line of data (the plurality of hash values) is written back to the one line of the original address as illustrated in (L) of FIG. 18. In relation to one line of data (the plurality of hash values) which is written back to the one line of the original address, the updated hash value is stored in the page containing data of an address to which data is newly written (refer to Q1).

The elements described above (152 to 164, 36, 38, and 28) are an example of the “rewriting unit” of the disclosed technology.

Next, description will be given of the effects of the fourth embodiment.

### First Effect

For example, when new data is input due to the data in the line #m of the memory being rewritten with new data, the memory controller 18 calculates the new partial hash value that is calculated from the plurality of data of the line #m containing the new data. The memory controller 18 calculates the difference between the new partial hash value of the line #m, and the old partial hash value of the line #m containing the old data before rewriting. The memory controller 18 performs the calculation of the hash value of the page by calculating the EOR between the hash value of the entire page before rewriting and the difference of the partial hash value. The memory controller 18 updates the hash value by causing the calculated hash value to be stored in the region of the original address of the hash value storage region 14B.

Accordingly, in the fourth embodiment, it is possible to maintain the hash value storage region 14B by following the rewriting of data in the memory.

Here, in the third embodiment, the hash value of the page containing data that may be rewritten is changed to a value indicating invalid. In contrast, in the fourth embodiment, the hash value of the page containing data that may be rewritten may be changed to a hash value based on the plurality of data of a page containing new data.

### Other Effects

The fourth embodiment has the same effects as the first to the fourth effects in the first embodiment.

Next, description will be given of a modification example of the fourth embodiment.

In the modification example of the fourth embodiment, in the same manner as in the first modification example of the first embodiment, an MPU is provided instead of the control circuit 20. In the modification example of the fourth embodiment, at least one of the error detection and correction circuit 30, each of the circuits (154 to 164) including the hash value calculation circuit 34, and the portion containing the line from the error detection and correction circuit 30 to the input terminal R of the selector 154 is omitted. In the modification example of the fourth embodiment, corresponding to the omission, at least one of the error detection and correction process and the calculation of the hash value is executed by the MPU according to a program. The modification example of the fourth embodiment has the same effects as the first modification example of the first embodiment.

Note that, the second modification example, the fourth modification example, and the other modification examples in the first embodiment may be applied as modification examples of the fourth embodiment.

All documents, patent applications, and technical specifications described in the present specification are incorporated by reference in the present specification to the same extent that the incorporation by reference of each of the documents, patent applications, and technical specifications is specifically and individually denoted.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transfer device that performs data transfer between a memory that stores a plurality of data and a processing unit that executes a main process using the data stored in the memory, the transfer device comprising:
a control unit that carries out control to, separately from the main process, sequentially read the data stored in the memory for each predetermined unit in address order, and to subject the read data to a predetermined process; and
a determination unit that determines a digest value for each of the plurality of predetermined units of data using the data read by the control unit or the data subjected to the predetermined process by the control unit.

2. The transfer device according to claim 1,
wherein the control unit carries out control to perform a memory scrubbing process which periodically subjects the data stored in a predefined region of the memory to error detection and error correction as the predetermined process, and
wherein the determination unit determines the digest value by using the data that is read from the memory and before subjected to the error detection and the error correction, or using the data after the error correction and before written back to the memory when the error correction is performed, or using the data after the error detection process when an error is not detected by the error detection.

3. The transfer device according to claim 2,
wherein the digest value that is determined by the determination unit is written to the memory, and
wherein reading of the data from the memory by the control unit, or writing of the digest value determined by the determination unit to the memory, or both the reading and the writing are performed when the processing unit is in an idle state in which the main process is not executed.

4. The transfer device according to claim 1,
wherein a transfer distance of the data between the memory and the transfer device is shorter than a transfer distance of the data between the memory and the processing unit.

5. The transfer device according to claim 1,
wherein the processing unit includes a cache,
wherein information indicating whether or not the data that is read from the memory for each predetermined unit and temporarily stored in the cache may be rewritten when the data is written back to the memory is written to the memory in correspondence with the data of each predetermined unit, and
wherein, when the information indicating whether or not the data may be rewritten that is written to the memory in correspondence with the plurality of predetermined units of the data indicates that the plurality of predetermined units of the data contains data that may be rewritten, the determination unit determines a predefined value as the digest value.

6. The transfer device according to claim 5,
wherein the digest value that is determined by the determination unit is stored in the memory, and
wherein the transfer device further comprises a rewriting unit that rewrites with predefined values digest values of the plurality of predetermined units of the data stored in the memory and containing the data that may be rewritten.

7. The transfer device according to claim 5,
wherein the digest value that is determined by the determination unit is stored in the memory, and
wherein the transfer device further comprises a rewriting unit that, when the data stored in the memory is to be rewritten with new data, rewrites digest values of the plurality of predetermined units of data containing the data to be rewritten with digest values of the plurality of predetermined units of data containing the new data instead of the data to be rewritten.

8. The transfer device according to claim 1,
wherein the determination unit is a hardware circuit.

9. A determination method executed by a transfer device which performs data transfer between a memory that stores a plurality of data and a processing unit that executes a main process using the data stored in the memory, the determination method comprising:
carrying out control to sequentially read the data stored in the memory for each predetermined unit in address order, and to subject the read data to a predetermined process; and
determining a digest value for each of the plurality of predetermined units of data using the read data or the data subjected to the predetermined process.

10. A data processing device comprising:
a memory that stores a plurality of data;
a processing unit that executes a main process using the data stored in the memory; and
a transfer device that performs data transfer between the memory and the processing unit, the transfer device including
a control unit that carries out control to sequentially read the data stored in the memory for each predetermined unit in address order, and to subject the read data to a predetermined process; and
a determination unit that determines a digest value for each of the plurality of predetermined units of data using the data that is read by the control unit or the data that is subjected to the predetermined process by the control unit.
